(19) United States
(12) Patent Application Publication
(10) Pub. No.: US 2017/0198867 A1
(43) Pub. Date: Jul. 13, 2017

(54) Field adjustable fluorescent or LED light fixtue with automatic and user programmable multiple control functions

(71) Applicants: Frank Albert Bilan, Clements, CA (US); Albert Lee Kramp, Stockton, CA (US); Robert Lee Williams, Stockton, CA (US)

(72) Inventors: Frank Albert Bilan, Clements, CA (US); Albert Lee Kramp, Stockton, CA (US); Robert Lee Williams, Stockton, CA (US)

(21) Appl. No.: 14/757,238

(22) Filed: Dec. 10, 2015

(51) Int. Cl. F21K 9/275; F21S 8/02; H05B 33/08; F21K 9/278; H05B 37/02; F21V 23/06; F21V 17/10

(52) U.S. Cl. CPC F21K 9/275; F21V 23/06; F21S 8/026; F21V 17/107; F21K 9/278; H05B 37/0272; H05B 37/0236; H05B 33/0854; F21Y 2115/10

(57) ABSTRACT

A novel light fixture assembly 300, 301, 330, 340, 360, 370 and 400 with built-in adjustable mounting plates 71, 72, 73, 75, 101, 102, 103, 101a, 102a, 103a, 178 and 188 is disclosed. Easy installation with minimum on-site adapter fabrication is provided. Additionally, a hinge mechanism 95, 96 is shown providing easy access to the interior of the light fixture assembly. Angular adjustment of the front face or faces of the light fixture is also possible using the said hinge mechanism. Various modern control functions are disclosed such as wireless and wired controls for light dimming, color change, timing, occupancy sensing, programmability etc.

### BACKGROUND

### Field of the Invention

The present invention relates to electrical light fixtures as predominantly used but not limited to office complexes laboratories and some industrial plants. Traditionally these fixtures are fluorescent tubes of various lengths and diameters. In recent years with the advent of the Light Emitting Diode (LED), these said LEDs have begun to replace the electrically less efficient fluorescent tubes.

An ongoing industry has sprung up solely for the purpose of retro-fitting the fluorescent tube fixtures with LED based fixtures. Due to smaller and lighter ballasts, both the fluorescent tube and LED fixtures are generally slimmer in size. The LED replacement fixtures are becoming the units of choice these days.

Unlike the fluorescent tubes, the LED fixtures are available with narrow or wide angle light emission characteristics.

Retrofitting into existing architectural structures causes some installation complexities such as fabricating adapter plates, spacers, cover plates etc.

The present invention adds a considerable amount of artificial intelligence to the LED lighting systems. Automatic and user programmable functions are discussed in detail. Just as the telephone of the previous century was only a land line telephone for person to person communication, it is now a wireless device capable of taking still pictures, moving pictures, downloading data, transmitting the said items, calling and conferencing multiple people, performing a myriad of tasks using “phone apps.” and other functions.

Indeed the time has come for lighting systems to acquire some of these modern contrivances. For example:
a. Automatic light dimming based on built-in ambient light sensors which, by the way, are becoming mandatory in office complexes in California.
b. Built-in occupancy sensors which turn on lights automatically when a person enters the room and turns off when the room is vacant, which are also becoming mandatory in office complexes in California.
c. Fire or flame detection causing the transmission of alarm signals.
d. Intruder detection based on the same said occupancy sensors.
e. Automatic spectral variation based on user programming.
f. Wireless communication capability for a variety of functions.
g. Public address functions with built-in loudspeaker devices/s.

This inventor understands that the addition of these various gadgets causes this patent application to cross a plurality of patent classes. But so have thousands of other patents done this as more and more capabilities are added to basic inventions. Why, even some household refrigerators are now connected to the internet!

### BRIEF DESCRIPTION OF THE PRESENT INVENTION

In a class of embodiments, the present invention consists of a light fixture with built-in movable plates located under the face plate of the fixture. In rare cases the movable plates can be placed above the front face plate. These plates have a plurality of holes and slots to allow dimensional adjustments of the front face plate upon which the fluorescent or LED light emitters are mounted. Generally the front plate (face plate) is a convenient method used to fasten at least a portion of the fixture to a ceiling cavity or to an existing fixture that has been gutted out of its old parts. The goal is to have little or no additional hardware to fabricate on site when retro fitting existing fixtures. The present invention remedies many of these installation encumbrances by providing a light fixture in which the front plate with its movable plate/s are field adjustable in both width and length. Additionally a hinging mechanism is disclosed for the provision of easy maintenance and versatility in light directional adjustment.

In other class/classes of embodiments, the present invention consists of a light fixture with built-in automatic and user programmable features.

### DEFINITION OF TERMS

For the purposes of the present disclosure, the Abstract portion of this document is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the inventive concept(s) of the application, which is measured by the claims, nor is it intended to be limiting as to the scope of the inventive concept(s) in any way.

For the purposes of the present disclosure, the phrase “A and/or B” means (A), (B), or (A and B). Also for purposes of the present disclosure, the phrase “A, B, and/or C” means (A), (B), (C), (A and B), (A and C), (B and C), or (A, B and C).

For the purposes of the present disclosure, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein include, for example, “multiple” or “two or more”. For example, “a plurality of items” includes two or more items.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AN) device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a wired or wireless network, a wireless area network, a Wireless Video Area Network (WVAN), a Local Area Network (LAN), a Wireless LAN (WLAN), a Wireless Metropolitan Area Network (WMAN) communication system, a Personal Area Network (PAN), a Wireless PAN (WPAN), devices and/or networks operating in accordance with suitable Wireless Chip Area Networks (WCAN) standards and/or protocols and/or future versions and/or derivatives thereof, devices and/or networks operating in accordance with existing IEEE 802.11 (IEEE 802.11-2007: Standard for Information technology—Telecommunications and information exchange between systems—Local and metropolitan area networks—Specific requirements, Part 11: Wireless LAN Medium Access Control (MAC) and Physical Layer (PH) Specifications—June 2007) standards (“the 802.11 standards”), 802.16 (IEEE-Std 802.16, 2004 Edition, Air Interface for Fixed Broadband Wireless Access Systems), 802.16d, 802.16e (IEEE-Std 802.16e, 2005 Edition, Physical and Medium Access Control Layers for Combined Fixed and Mobile Operation in Licensed Bands) standards (“the 802.16 standards”) and/or future versions and/or derivatives thereof, devices and/or networks operating in accordance with existing Wireless-Gigabit-Alliance (WGA) and/or Wireless HD™ specifications and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra-Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee.™, Ultra-Wideband (UWB), Global System for Mobile communication (GSM), 2G, 2.5G, 3G, 3.5G, Enhanced Data rates for GSM Evolution (EDGE), or the like. Other embodiments may be used in various other devices, systems and/or networks.

For the purposes of the present disclosure, the term “wireless device” as used herein includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may be used to provide a wireless service.

The descriptions may use perspective-based descriptions such as top/bottom, in/out, over/under and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising”, “including”, “having”, and the like as used with respect to embodiments of the present disclosure, are synonymous.

The term “coupled with”, along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

In this teaching, the expression “PCB” denotes a printed circuit board generally bonded to a thin metal cladding. The printed circuit board itself may be extremely thin, in the order of 0.005 inches or so and is a very poor conductor of heat, about 0.25 W/mK, (where W is watts of power, m is the area in square meters thru which the heat is conducting and K is the temperature difference in degrees Kelvin) hence the extreme thinness used. The said thin PCB is chemically bonded to an aluminum substrate, a good conductor with a thermal conductivity of about 140-201 W/mK (depending on the metal alloy) whose thickness is substantially greater. The said metal substrate thickness can be as thin as 0.02 to 0.125 inches or more.

Unless otherwise specified, throughout this disclosure, including in the claims, the expressions “LED” denotes a light emitting diode generally emitting a white light. It can also refer to a red, green, blue or yellow light emitting diode. It can also refer to an RGB multi-chip diode assembly (RGB denotes a red/green/blue diode assembly in one package, capable of emitting each of its colors separately or all together, simulating white light at a distance).

Unless otherwise specified, throughout this disclosure, including in the claims, the expressions “OLED” (Organic Light Emitting Diode) denotes a light emitting device creating light with organic based technology rather than silicon semiconductor based technology. It is presently used in some cell phones. It can also refer to a red, green, blue or yellow OLED. It can also refer to an RGB OLED device. (RGB denotes a red/green/blue OLED device).

The term “LED array” or “LED array assembly” generally refers to a printed circuit board having a plurality of LEDs mounted thereon in a generally, but not limited to, a row and column fashion.

The term “zero power self-regulation of current” means current control of semiconductor devices such as LEDs for example that use on-chip fast switching devices that switch the LED on and off very fast, using short duration pulses so that there is no time for destructively large LED currents to build up. These very fast switching devices dissipate very little power hence the name “zero power”. Current regulation of the said LED devices is accomplished by controlling the number of these applied pulses in a given time—a form of pulse repetition control. High speed PWM could theoretically also be used, but is much more critical in application, since theoretically 100 percent PWM is full direct current power to the LED. Therefore a partial PWM method should be used.

The term “positive temperature coefficient” refers to a future semiconductor or non-semiconductor light emitting device that consumes less electrical current as it heats up. Present silicon semiconductor LED devices have an opposite characteristic; they consume more electrical current as they heat up.

Unless otherwise specified, the expression “Fluorescent light replacement fixture” or “LED fluorescent light replacement fixture” refers to a light fixture whose primary function is just that; a new fixture for replacement of the old fixture with minimal cost of material and labor. However it can also be used for new installations where there was no fixture previously present.

Thru out this teaching, light fixture X and Y axes are as shown in FIG. 1, the long side being the Y axis, the short end side being the X axis and the Z axis being the depth of the fixture housing.

Unless otherwise directly or indirectly or by context defined, the expression “master unit” and/or “slave unit” refers to a light fixture that can come in two configurations; A light fixture that has built-in controlling functions to control a plurality of other light fixture units and a simpler light fixture that cannot control other light fixture units, but is capable of being controlled by the master light fixture unit.

Unless otherwise directly or indirectly or by context defined, the term “tube” refers to a fluorescent tube light source.

Unless otherwise directly or indirectly or by context defined, the expression “fixture” denotes an electrical light fixture which consists of a housing and a front face upon which the light source/s is/are mounted. The housing is generally perimetrical in form as an elongated rectangular box with the longest dimension, Y, being four or more times longer than the X dimension and the Z dimension being the least. One side on the X-Y plane is missing, forming an elongated open box structure. The said housing is made of light gauge sheet metal. A face plate containing the light source/sources is mounted upon the said open side. The said housing can also be made of a variety of non-metal materials such as plastics of various compositions and fiberglass of various grades etc.

Unless otherwise directly or indirectly or by context defined, the expression “face” or “front face” denotes the visible front portion of a light fixture containing the light source or sources such as the fluorescent tube/tubes or LED array/arrays. It does not refer to the plastic or glass bezel covering the naked tube/tubes or LED array/arrays.

Unless otherwise directly or indirectly or by context defined, the expression “plate” or “panel” or “movable plate” or “slide plate” or “slide panel” refers to a generally thin steel or aluminum sheet metal as commonly used in the fluorescent lighting industry. It is usually 0.03″ to 0.04″ thick and fastened with sliding allowance to the face plate which can also be, but not limited to be, of similar thickness as the said plates/panels. However, in this teaching, this inventor does not concede that these are limiting dimensions but is rather teaching the current practice in the industry.

Unless otherwise specified, the expression “movable plate” refers to a generally thin steel or aluminum sheet metal as commonly used in the fluorescent lighting industry. It is usually 0.03″ to 0.04″ thick. The said movable plate is mounted above or below the face plate and is loosely fastened to the said face plate, allowing movement back and forth as desired for proper installation purposes. It may also contain holes and/or slots to allow this movement while still loosely attached to the face plate. Upon successful installation, the movable plate is tightly fastened to the face plate, resulting in a rigid assembly of movable plate and face plate.

Unless otherwise directly or indirectly or by context defined, the expression “L bend” refers to a generally 90° bend in a thin piece of sheet metal as used in this invention and referred to as a “plate” or “panel”. (The term 90° means exactly that—within the accuracy limits of standard sheet metal industry practice. The intent of this teaching and in the claims is that 90° is in fact a variable, dependent on the accuracy of the sheet metal vendor's metal work.) The “L” bent section is generally in the order of a ½″ to ¾″, but in special cases it can be more or less.

The expression “mechanical coupling” refers to plate or other device that is fastened to another body; for example a side of an electrical fixture housing unit.

The expression “variable mechanical coupling” refers to plate that is movable in the X or Y direction with the intent of adjusting the length or width of a face plate in combination with its said movable plate.

The term “dimensional adjustment capability” refers to the ability of a front face of a light fixture in combination with a movable plate under or over a portion of said front face to have the ability of expanding or contracting its combined visible area. The said expanding or contracting of the said combined visible area gives it the ability to be installed in places of differing dimensions without custom tooling or custom panels.

The expression “mounted” generally applies to a fixture affixed in its place using industry professional procedures such as bolting, screwing, nailing gluing etc.

Unless otherwise defined expressly or by context, the expression “site” or “area” generally applies to a place where a light fixture is, was, or is to be installed. It does not mean exactly at that said site or area, but the general vicinity as decided by the installation professional or customer/client.

The term “ballast” can refer to an inductive electrical current limiting device or an electronic device that may perform both current limiting and power supply functions. In special cases, other electronic control functions may be incorporated. For example, wireless control for on or off, Pulse Width Modulation of LEDs, timing devices, occupancy sensor/s, photo sensor/s etc.

Thru out this teaching, electrical wire connections will not be shown. They are well known to the lighting industry art.

Thru out this teaching, light fixture bezels, dust covers, decorative trim etc. will not be shown. They are well known in the architectural art.

Thru out this teaching, light fixture control devices will not be illustrated. Typical ballasts may be shown. A photo sensor, occupancy sensor, a timing device, a computing device, a transmitter, a receiver etc. will not be shown.

Thru out this teaching, the term “distal” is in reference with the observers eyes; distal being further away, while proximal would be closer to the observers eyes.

### BRIEF DESCRIPTION OF THE PRIOR ART

Several devices related to the present invention have been identified during this inventor's Due Diligence Search. They are as follows:

Patent U.S. Pat. No. 3,989,335 to Belokin, Jr. illustrates a common fluorescent light fixture as used by millions of buildings throughout the world. Belokin, Jr. shows a box like housing 10 a front face (not clearly numbered) on which two fluorescent tubes 12 are mounted in sockets 20. This is the type of fixture this present invention is addressing for modernization with newer fluorescent tubes or with LED technology.

Patent U.S. Des. 348,947 to Holcomb illustrate another common fluorescent light fixture. FIG. 14 clearly shows a face plate assembly and the housing, completing the fixture. This present invention is addressing this type of fixture also for modernization with LED technology.

Patent U.S. Pat. No. 6,964,502 to Verfuerth discusses replacing an entire fluorescent light fixture with a new one. It is not a dimensionally adjustable fixture. The Verfuerth patent is a good example of using plastics to replace metal for cost reduction. Verfuerth illustrates a front face assembly 20, in FIG. 10. Verfuerth illustrates integrally molded plastic hinges 16 on the front face assembly in FIGS. 2-6 and others. This invention does not illustrate or discuss an integral-to-face-plate type of plastic deformation hinge, but does claim this said type of hinge as a separate hinge assembly. This present invention is addressing a fluorescent light fixture that is adjustable in width/length for retrofitting to a wide variety of light fixture cavity/s or existing light fixture housing/s that have been gutted of its/their front face/s and selected internal parts.

Patent U.S. Pat. No. 7,080,923 to Plunk discusses a Fluorescent Strip Light Fixture Retrofit Kit wherein a new front face is installed over the old housing whose front cover is removed. Plunk changes the depth of the fluorescent fixture substantially, precluding most flush ceiling mounted fluorescent fixture replacements. Plunk does not discuss variable dimensional capability or removal of any of other internal old fixture parts. Neither does Plunk discuss LED technology. This disclosure discusses these said items.

Patent U.S. Pat. No. 8,668,361 to Hasnain et al. discusses replacing individual fluorescent light tubes and using the original ballasts in the old fixture. This is not the goal of the present invention. The present invention replaces all of the tubes with newer fluorescent tubes and ballasts or with LED technology with their LED ballast/s. The cost of modern ballasts is relatively low and replacing tube by tube is ungainly in sight and ultimately not cost effective. Hasnain unknowingly admits this since in column 7 lines 14-17 he states: “When all the fluorescent tubes have finally been replaced, the existing ballast could, in principle, also be replaced to provide higher overall power conversion efficiency.” This begs the question—since only a skilled professional is qualified to do this, why not do this in one shot and get it over and done with?. Additionally, to save cost of tube inventory, why not move all good tubes to other fixtures and modernize one or more complete multi-tube fixtures at a time?

Patent U.S. Pat. No. 8,814,376 to Nicolai et al. discusses a LED replacement for fluorescent light fixtures. Nicolai uses an entirely different scheme utilizing a “mixing chamber” as part of his invention. This is an excellent design, but a little expensive. The present invention does not discuss light mixing etc. and leaves this part open to other inventive mixing techniques which this inventor will ponder.

Patent U.S. Pat. No. 8,896,207 to Thomas et al. discusses a LED replacement for fluorescent light fixtures. Thomas discusses LED replacement for fluorescent tubes in a general way with circuit techniques to power the said LEDs. He also discusses powering the said LEDs using the existing ballast. This is not the intent of the present invention.

Patent U.S. Pat. No. 7,794,114 to Medendorp, Jr. primarily discusses innovative methods of conductive heat spreading of LED lighting devices. Medendorp, Jr.'s invention is an excellent example of using advanced heat spreading technology. In column 1 lines 40-43 he discusses a cover with hinges. These hinges are not the hinges discussed in this disclosure. Medendorp, Jr. additionally discusses in column 3 lines 61-64 multiple color LEDs. However he places these said LEDs on a thermally anisotropic substrate whereas this disclosure does not use such material. The present invention uses relatively low power LEDs in multiple array formats thus spreading the heat efficiently over the entire front face of the fluorescent light fixture.

Patent U.S. Pat. No. 8,921,751 to Verfuerth discloses a light fixture intended for street lights. Verfuerth shows in FIG. 1 a set of hinges. Once again these hinges are not as discussed in the present invention. Verfuerth also discusses a variety of complex communication systems associated with these said light fixtures. They are not the type discussed in this disclosure. The present invention does not claim a hinge for the fluorescent light fixtures, but does claim hinges for the face plates of LED fluorescent light replacement fixtures.

Patent U.S. Pat. No. 7,507,001 to Kit generally discloses a LED light in a fluorescent tube configuration. This is a vast tome of a patent and will be discussed in some detail. First of all it does not discuss a fluorescent replacement LED front face replacement technology of the present invention. But does discuss a myriad of methods of power control systems, both wired and wireless for these said LED lights. This prompts a discussion of Kit's claims as follows:—

CLAIM 1 Kit states: “A light emitting diode (LED) lamp for mounting to a fluorescent light fixture . . . including an LED electrical circuit . . . positioned within said tube and generally extending between said tube ends.”—This is not done in the present invention. The present disclosure discusses the replacement of at least the entire front face of the old fluorescent light fixture with a complete LED array and a LED ballast mounted in the housing.
CLAIM 6 discusses a switch in each LED tube. The present invention does not. It allows a switch or a plurality of switches for the entire LED light fixture assembly or selected rows/columns.
CLAIM 7 discuses a photo sensor. The present invention does not discuss a photo sensor in each tube, but it allows one or more for the entire LED fluorescent light replacement fixture.
CLAIM 15 discuses an occupancy sensor. The present invention does not discuss an occupancy sensor in each tube, but it allows occupancy sensor/s for the entire LED fluorescent light replacement fixture.
CLAIM 20 discuses a computer in the tube of claim 1. The present invention does not discuss a computer in terms of a tube of LEDs. It does allow a computing device for controlling the entire light fixture of the present invention.
CLAIM 21 discusses a dimmer for the LED tube of claim 1. The present invention does not. It discusses various Pulse and/or Pulse Frequency Modulation or other dimming controls for the entire LED fluorescent light fixture.
CLAIM 24 discusses the transmission of a signal path to a photo sensor in each tube. The present invention does not. It may discuss a signal path/s for the entire fixture.
CLAIM 25 discusses the wireless transmission of a signal path to a photo sensor in each tube. The present invention does not. It may discuss a signal path/s for the entire fixture.
CLAIM 26 discusses the PLC (Power Line Control) transmission of a signal path to a photo sensor in each tube. The present invention does not. It may discuss one or more for the entire fixture.
CLAIM 36 discusses a second LED lamp. The present invention does not have a second LED lamp. It has one fixture with a large plurality of low power LEDs across the entire face of the fluorescent light fixture.
CLAIM 51 discusses OLED light emitting devices in place of LEDs. The present invention allows the same technology, but placed as an array across the entire front face of the fluorescent light fixture not in a tube as indicated in claim 1 of Kit's patent.
CLAIM 52 discuses a timer. The present invention does not discuss a timer in each tube, but it allows one or more for the entire LED fluorescent light replacement fixture.
CLAIMS 53-57 discuss various electrical protection circuitries to the LED tubes. The present invention allows the entire LED fluorescent light replacement fixture to have power conditioning and protection.
CLAIMS 58 and 59 discuss a method of supporting the LED devices and then supporting the LED assembly in a tube. The present invention does not.

Patent U.S. Pat. No. 9,112,173 to Mitsuya discusses high brightness and long life OLED devices and is included here as a cited document to demonstrate the reality of up-coming future solid state lighting devices.

The present invention claims various wired/wireless control of the LED fluorescent light fixtures in all or most of its embodiments. Many of these control devices are available commercially and most of them are protected by their own IP portfolios. The present disclosure may use commercial control devices or it may design its own said control devices. The present disclosure also discusses future solid state lighting technology. See the section: FUTURE CAPABILITY OF SOLID STATE LIGHTING DEVICES.

### BRIEF DESCRIPTION OF THE DRAWINGS

The object and features of the present invention, as well as various other features and advantages of the present invention will become apparent when examining the description of various selected embodiments taken in conjunction with the accompanying drawings in which:

FIG. 1 shows a partially exploded perspective view of a typical fluorescent light fixture.

FIG. 2 shows a partially exploded perspective view of a typical LED light fixture.

FIG. 3 shows a partially exploded perspective view of a typical fluorescent light fixture mounted into a ceiling cavity.

FIG. 4 shows a partially exploded perspective view of a typical LED light fixture mounted into a ceiling cavity.

FIG. 5 shows a ceiling view of a typical fluorescent light fixture mounted into a ceiling cavity.

FIG. 6 shows a ceiling view of a typical LED light fixture mounted into a ceiling cavity.

FIG. 7 shows a ceiling view of a typical LED light fixture mounted into a ceiling cavity using one custom fabricated adapter plate.

FIG. 8 shows a ceiling view of a typical LED light fixture mounted into a ceiling cavity using two custom fabricated adapter plates.

FIG. 9 shows standard adapter plates as used in a various embodiments of the present invention.

FIG. 10 shows standard adapter plates as used in one embodiment of the present invention installed in a ceiling cavity.

FIG. 11 shows a partially exploded side view of a typical prior art LED light fixture.

FIG. 12 shows an assembled side view of an LED light fixture of a first embodiment of the present invention.

FIG. 13 shows an assembled end view of an LED light fixture of a second embodiment of the present invention.

FIG. 14 shows an assembled end view of an LED light fixture using a third embodiment of the present invention.

FIG. 15 shows an assembled end view of an LED light fixture of a fourth embodiment of the present invention.

FIG. 16 shows an assembled end view of an LED light fixture of a fifth embodiment of the present invention said fixture.

FIG. 17 shows an assembled end view of an LED light fixture of a fifth embodiment of the present invention demonstrating movement of the movable plate of said fixture.

FIG. 18 shows an assembled end view of an LED light fixture of a sixth embodiment of the present invention demonstrating movement of the movable plate of said fixture.

FIG. 19 shows a view of a typical fluorescent light fixture mounted to a ceiling surface with no ceiling cavity.

FIG. 20 shows a partially exploded view of a typical LED light fixture mounted to a ceiling surface with no ceiling cavity.

FIG. 21 shows an assembled view of a typical LED light fixture mounted to a ceiling surface with no ceiling cavity.

FIG. 22 shows an assembled end view of an LED light fixture of the present invention demonstrating angular movement of the top portion of said fixture.

FIG. 23 shows an assembled end view of an LED light fixture of the present invention demonstrating angular movement of two split top portions of said fixture.

FIG. 24 shows an assembled end view of an LED light fixture of one the embodiments of the present invention demonstrating angular permanent placement of the top portion of said fixture.

FIG. 25 shows a first cover plate.

FIG. 26 shows an assembled end view of an LED light fixture of one the embodiments of the present invention demonstrating angular permanent placement of two top portions of said fixture.

FIG. 27 shows a second cover plate.

FIG. 28 shows an assembled end view of an LED light fixture of a seventh embodiment of the present invention.

FIG. 29 shows a magnified view of an LED light fixture of a seventh embodiment of the present invention.

FIG. 30 shows a magnified view of an LED light fixture of a seventh embodiment of the present invention with a fastener variation.

FIG. 31 shows an LED surface mount chip with wide angle light emission.

FIG. 32 shows an LED surface mount chip with narrow angle light emission.

### DETAILED DESCRIPTION OF THE PREFERRED EMBODIMENTS

For easier understanding of the present invention, where possible, each figure is explained as a stand-alone explanation of that said figure. Therefore:

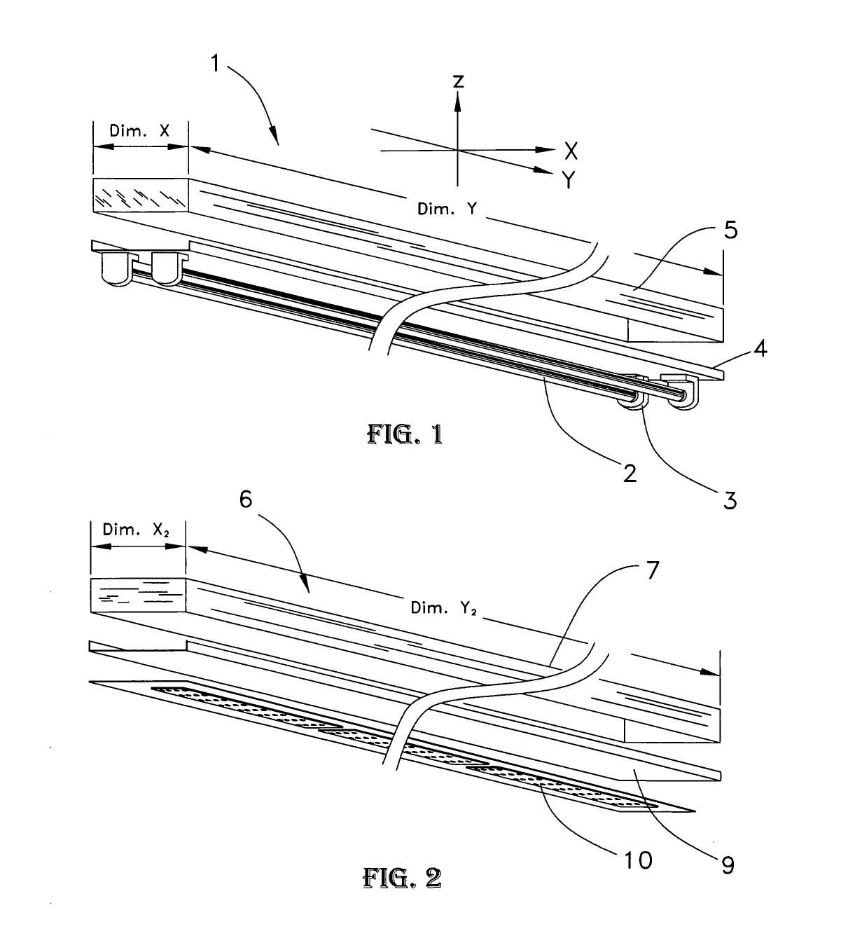

FIG. 1 shows a partially exploded view of a conventional fluorescent fixture 1 that has been manufactured for more than sixty years. It consists of an elongated steel open box like housing structure 5 with front plate 4 acting as a cover and tubes 2 mount areas. The tubes 2 are mounted on sockets 3 bolted or riveted on front plate 4. The older, larger and heavier fixtures were generally mounted in the ceiling cavities with bolts or screws at the back side of the housing 5 structure. Within the housing 5 was also bolted one or more rather bulky inductive ballasts (not shown). Slimmer and lighter units can be mounted in a variety of ways. Dimension X in FIG. 1 varies depending on the number of tubes placed side by side whereas dimension Y varies depending on the length of the tubes etc. This is well known in the art of fluorescent fixtures,

FIG. 2 shows a partially exploded view of a typical LED fluorescent replacement fixture 6. It consists of an elongated steel open housing structure 7 with a front plate 9 acting as a cover and LED assembly 10 mounting area. Dimension X₂ in FIG. 2 varies depending on the number of LED strips 10 placed side by side whereas dimension Y₂ varies depending on the length and number of the LED strips 10 mounted end to end. The said LED strips are purchased by lighting professionals as a complete assembly and come in various widths and lengths. These LED lighting strips are virtually all manufactured using surface mount technology. In all of the lighting fixtures being discussed, the depth or Z dimension as shown in FIG. 1 is governed by the ballast size. Surprisingly, today they can be merely an inch or more tall with a length of a few inches.

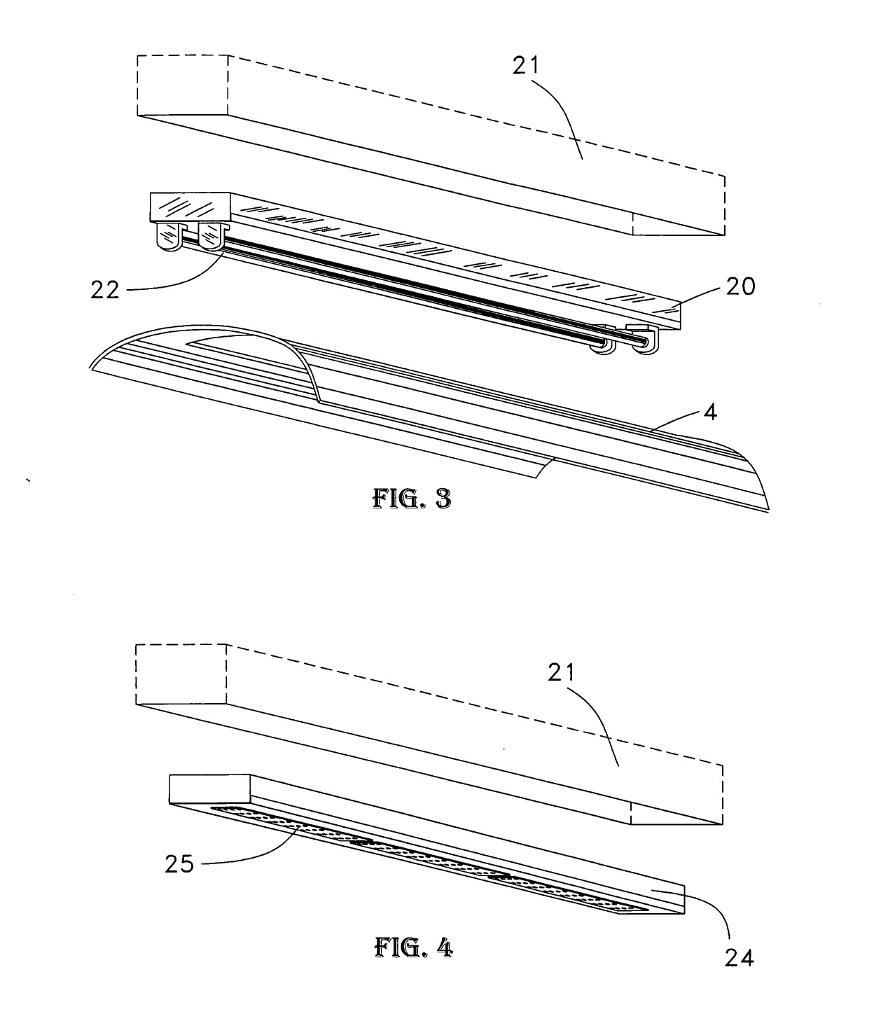

FIG. 3 shows a partially exploded view of a conventional fluorescent light fixture housing portion 20 with mounted tubes 22 being mounted into a ceiling cavity 21. Sometimes, generally in an industrial area, a reflector hood 4 may be used. (A ceiling cavity may be omitted and the fixtures simply mounted directly or being hung on chains or steel cables etc. This will be discussed later in this document)

FIG. 4 shows a partially exploded view of a typical LED fixture housing portion 24 with LED strip assembly 25 being mounted into same type ceiling cavity 21. Generally a reflector hood is not used since LED devices have a less than 180 degree emission directionality, whereas tubes have 360 degree emission characteristic about their individual radial coordinate.

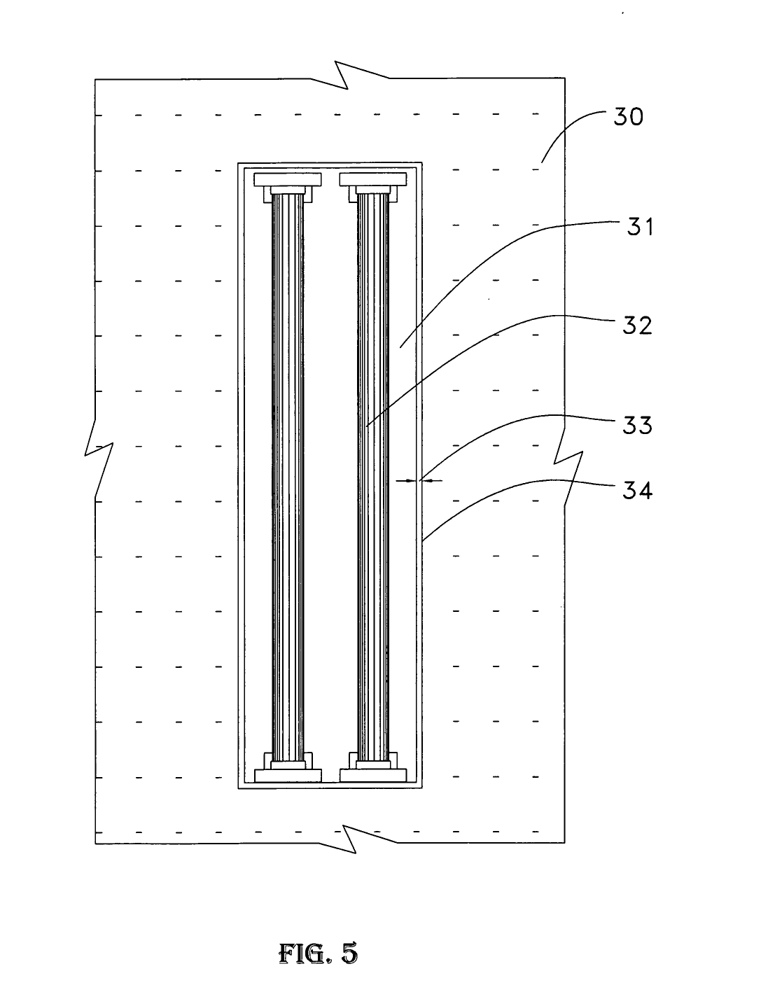

FIG. 5 shows a view of a conventional fluorescent fixture 31 mounted into a ceiling cavity 34 in a ceiling 30. The view is looking up from the floor to the ceiling. Note that gap 33 is very small.

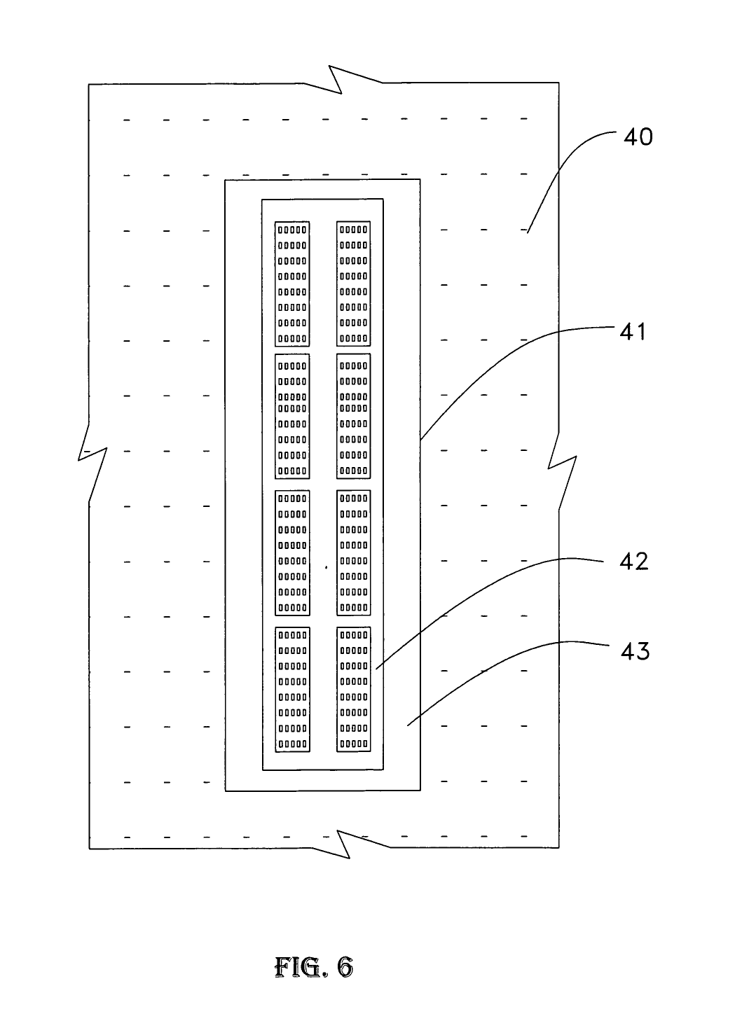

FIG. 6 shows a view of a conventional LED fixture 42 mounted into a ceiling cavity 41 in a ceiling 40. The view is looking up from the floor to the ceiling. Note that gap 43 is very large.

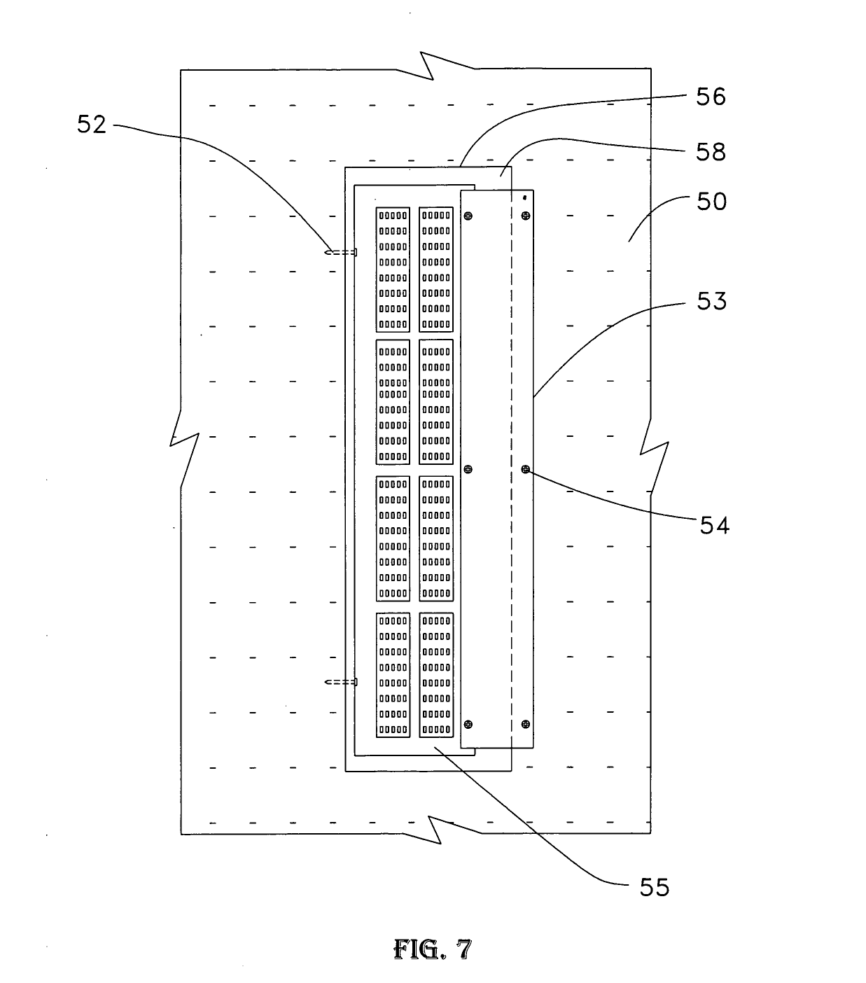

FIG. 7 shows a view of a conventional LED fixture 55 mounted into a ceiling cavity 56 in a ceiling 50. The view is looking up from the floor to the ceiling. Note that gap 58 is very large.

Said figure illustrates that a partial solution is to offset the fixture to the left and fasten screws 52 to the left side and fabricate a cover panel 53 and mount it to the ceiling 50 and front face of fixture 55 using screws 54.

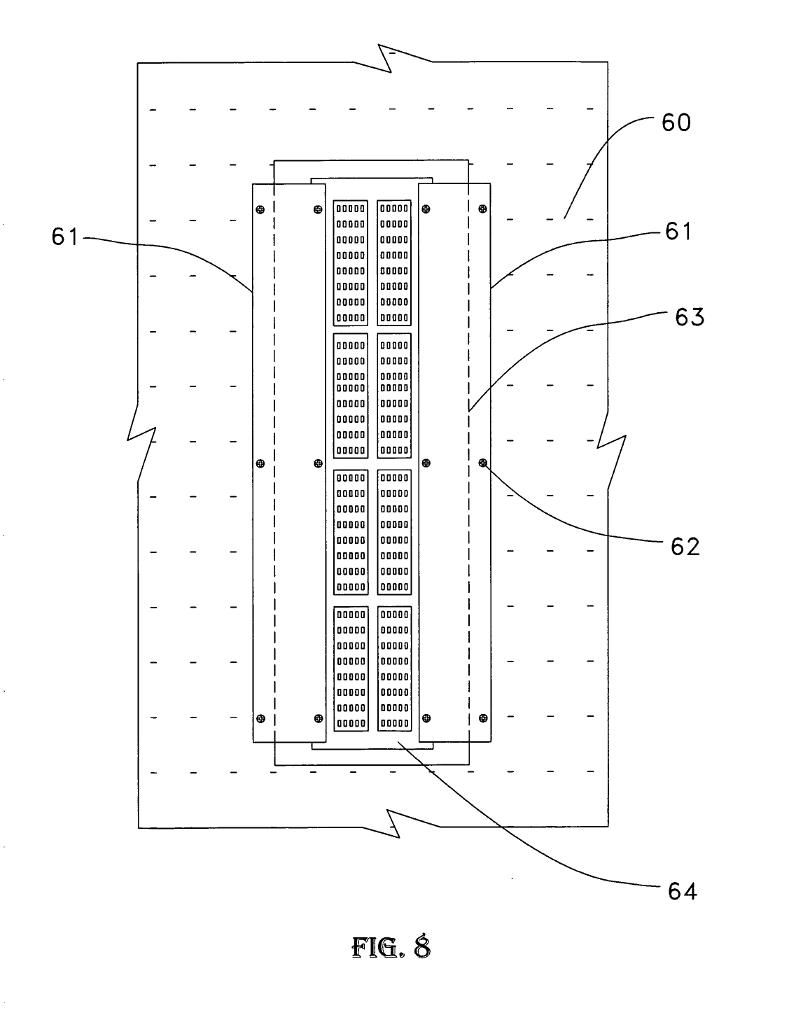

FIG. 8 illustrates that another partial solution is not to offset the fixture to the left but use two plates 61 and fastening screws 62 to the ceiling 60 and front of fixture 63. Both figures FIG. 7 and FIG. 8 are laborious and costly.

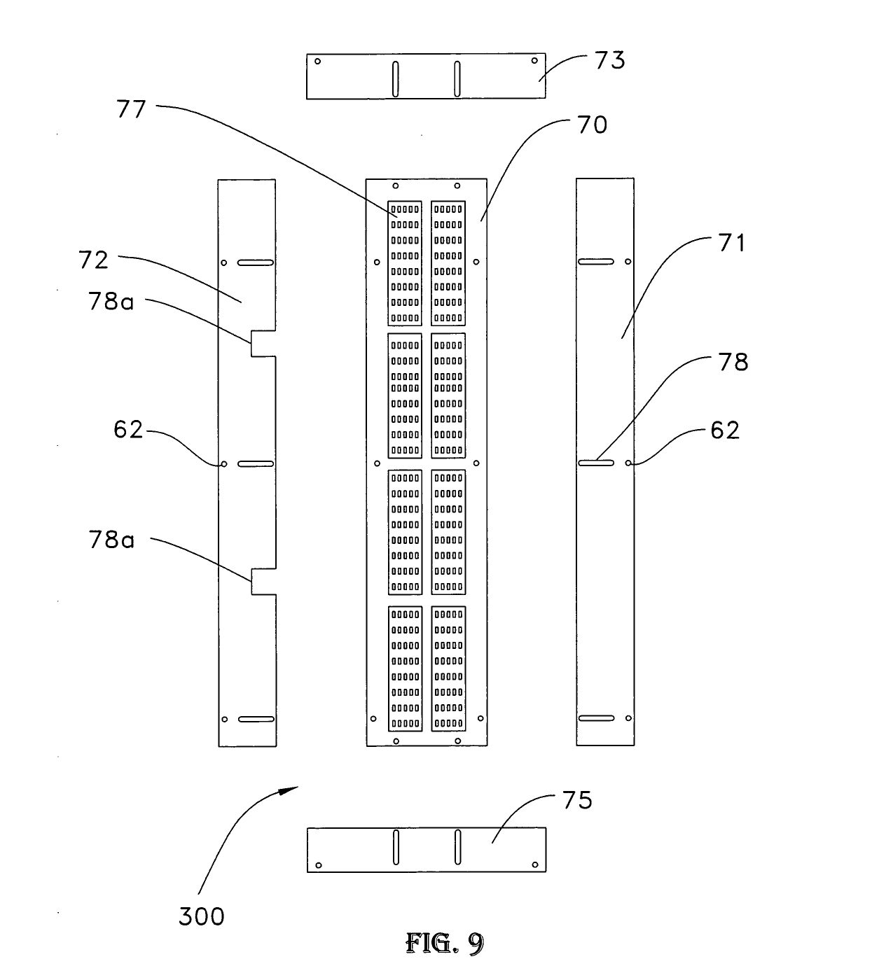

FIG. 9 illustrates an exploded view of one of the embodiments of the present invention. The view is a plan view looking down towards the front face of the fixture. What is shown is a fixture 300 with a front panel 70 upon which are mounted LED light strips 77. Two thin plates, (sometimes called panels) 71 and 72 are shown, one on each side of the fixture 70. These panels normally reside under the front panel 70 and are fastened with sliding capability to the said front panel portion during manufacture. Various slots 78 are provided in the panels to allow sliding into position during installation. Notches 78a are also shown on one of the said panels to allow sliding past hinges that may be installed on the front face of said fixture. Two other smaller end panels 73, 75 are also shown. These are optional and not used very often since fluorescent light fixtures are generally fairly consistent in their length specification. However these said smaller panels are shown for completeness of the teaching. It may be said that not all these panels are used in any one installation. There may arise the need to use none or one or two or all. The supplier of these fixtures can supply these fixtures with the required number of these options. This teaching claims all these various possibilities by reference. Note also the various holes 62 that are used for mounting the fixture to a ceiling cavity or to an existing old fixture that has had its old front face removed.

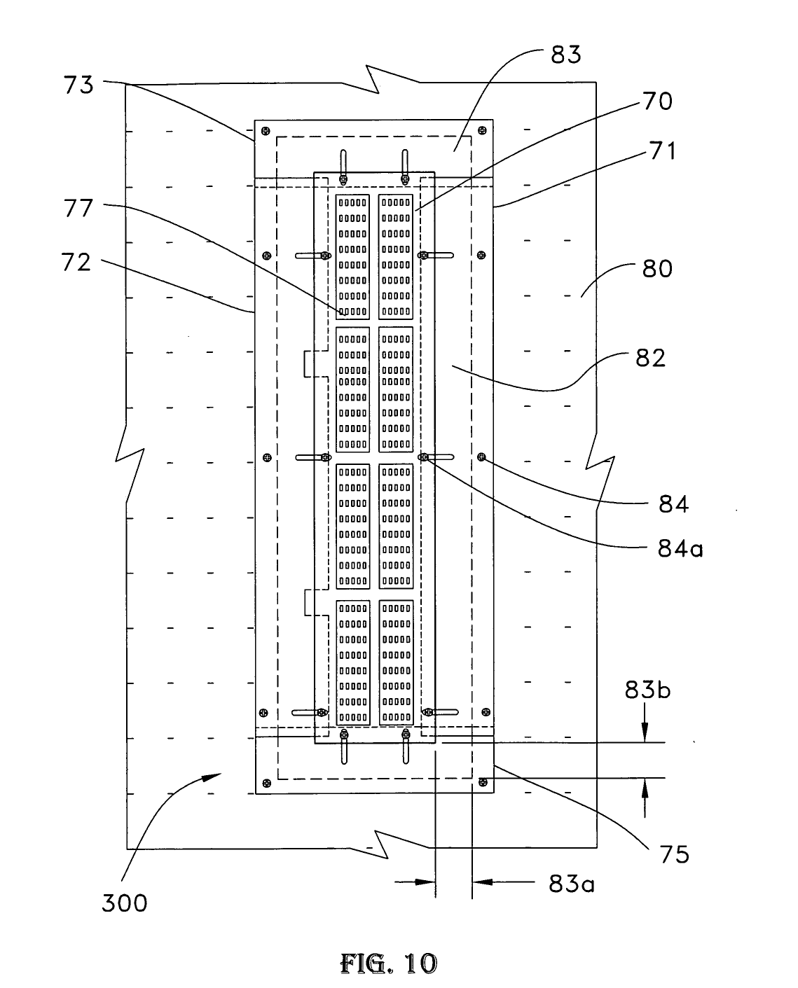

FIG. 10 illustrates an installation of the components of FIG. 9. The view is a plan view looking up towards ceiling 80. What is shown is a fixture 300 with a front panel 70 upon which are mounted LED light strips 77. Two thin panels 71 and 72 are shown, one on each side of the fixture 70. These panels 71, 72 are now slid out from under the front face 70 of fixture and extended to bridge the ceiling cavity gap 83 and are fastened down to the fixture face 70 with screws 84a plus the ceiling cavity edge with screws 84. Optional end pieces 75, 73 are also shown mounted in the same manner. X and Y dimensions 83a and 83b clearly show the gap 83 being covered by said panels. Note: screws 84a can be replaced with other fastening devices; for example, pressed in stods with retaining clips etc.

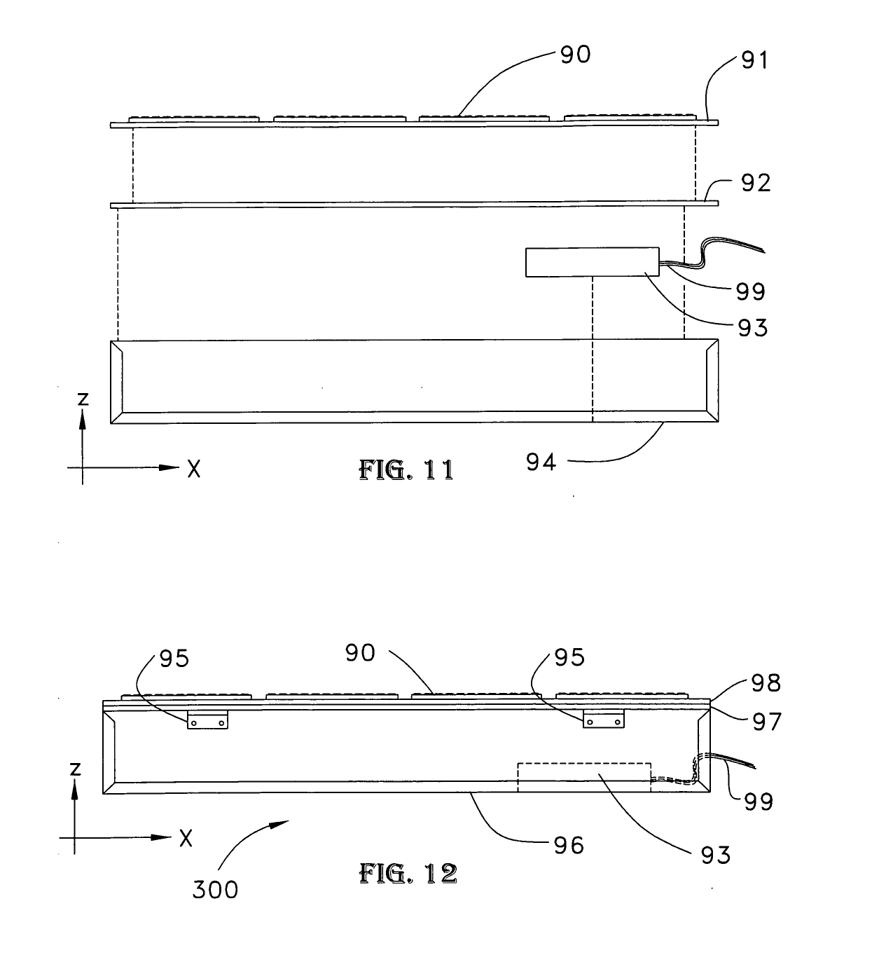

FIG. 11 shows a partially exploded view of a conventional LED fixture. It consists of LED light panels 90 mounted on a plate 91 which in turn is affixed to a front face plate 92. A housing structure 94 is shown with a ballast 93 and power cord 99.

### FIRST EMBODIMENT OF THE PRESENT INVENTION

FIG. 12 shows an assembled view of an LED fixture 300 of the present invention. It consists of LED light panels 90 mounted on a plate 98 which in turn is affixed to a front face plate 97. A housing structure 96 is shown with a ballast 93 and power cord 99. Additionally two hinges 95 are shown, allowing the opening of the fixture for gaining access to the interior of the fixture. Previously mentioned slide plates are not shown. Only the hinge feature is illustrated.

### SECOND EMBODIMENT OF THE PRESENT INVENTION

FIG. 13 shows an assembled end view of an LED fixture 300 of the present invention. It consists of LED light panels 90 mounted on a plate 98 which in turn is affixed to a front face plate 97. A slide plate 101 is shown. Hinges 95 are shown (One behind the other in this view). Note that one of the flaps of each hinge is mounted to one side of housing 96 while the other flap of the hinge is fastened to bottom of front face 97 A housing 96 is shown with a ballast 93. The hinges 95 allow the opening of the fixture for gaining access to the interior housing of the fixture and other uses which will be shown later.

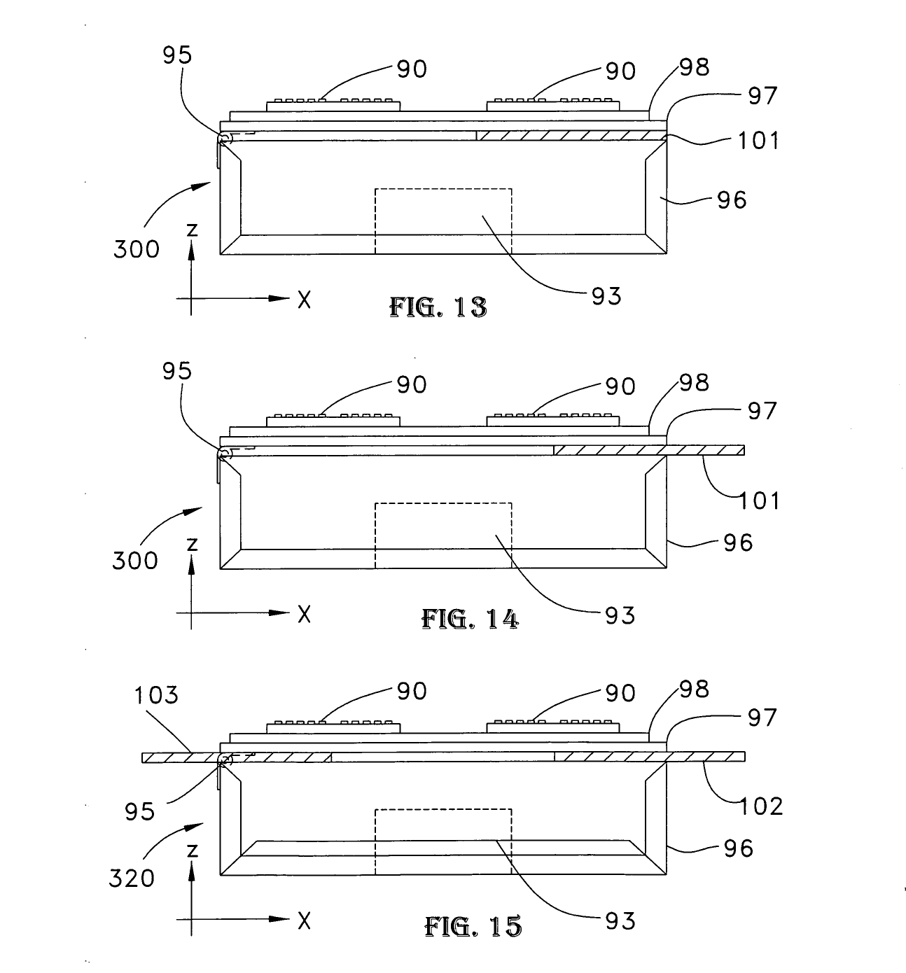

FIG. 14 shows an assembled end view of an LED fixture 300 of the present invention. It consists of LED light panels 90 mounted on a plate 98 which in turn is affixed to a front face plate 97. A slide plate 101 is now shown extended out, ready for installation where one side is extended as illustrated in FIG. 7, but this time there is no need to fabricate a custom plate since it is built in to the fixture. Hinges 95 are also shown.

### THIRD EMBODIMENT OF THE PRESENT INVENTION

FIG. 15 shows an assembled end view of an LED fixture 320 of the present invention. It consists of LED light panels 90 mounted on a plate 98 which in turn is affixed to a front face plate 97. Two slide plates 102, 103 are now shown extended out, ready for installation where two sides are extended as illustrated in FIG. 8, but this time there is no need to fabricate two custom plates since they are built in to the fixture. Hinges 95 are also shown.

### Inventor's Comment.

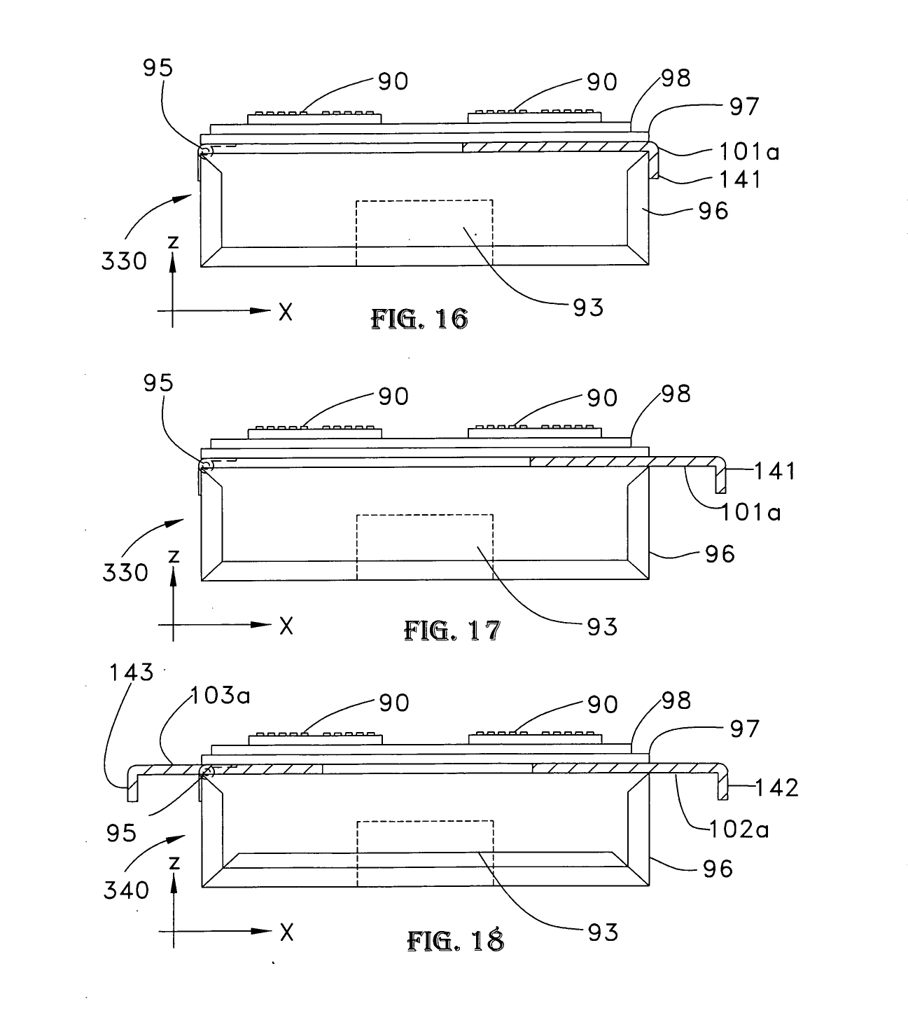

So far this teaching has discussed retrofitting LED and more modern fluorescent fixtures into recessed ceiling cavities. This is not always the case as there are many places where said fixtures are mounted on non-cavity ceiling surfaces directly or hung on cables, wires or chains. This is most prevalent in industrial and warehouse areas where architectural beauty is not as prevalent as in professional places of work activity. Then, when retrofitting these fixtures, generally only the front face portion of the LED or new fluorescent fixture is replaced and the original housing is used. This is done to save electrical re- wiring labor, re-installation labor and material costs. This can be quite significant since many industrial fixtures are hard wired using rigid conduit etc. The adapter plates (101, 102 and 103, in FIGS. 13, 14, and 15) are made with 90 degree “L” bends so that they may be fastened to the side of the fixture. FIGS. 16 thru 21 depict this. (End of comment.)

### FOURTH EMBODIMENT OF THE PRESENT INVENTION

FIG. 16 shows an assembled end view of an LED fixture 330 of the present invention. It consists of LED light panels 90 mounted on a plate 98 which in turn is affixed to a front face plate 97. A slide plate 101a is shown With an L bend 141. Hinges 95 are shown (One behind the other in this view). Note that one of the flaps of each hinge is mounted to one side of housing 96 while the other flap of the hinge is fastened to bottom of front face 97 A housing 96 is shown with a ballast 93. The hinges 95 allow the opening of the fixture for gaining access to the interior housing of the fixture and other purposes.

FIG. 17 shows an assembled end view of an LED fixture 330 of the present invention. It consists of LED light panels 90 mounted on a plate 98 which in turn is affixed to a front face plate 97. A slide plate 101a with an L bend 141 is now shown extended out, ready for installation where one side is extended as illustrated in FIG. 7, but this time there is no need to fabricate a custom plate since it is built in to the fixture. Hinges 95 are also shown.

### FIFTH EMBODIMENT OF THE PRESENT INVENTION

FIG. 18 shows an assembled end view of an LED fixture 340 of the present invention. It consists of LED light panels 90 mounted on a plate 98 which in turn is affixed to a front face plate 97. Two slide plates 102a, 103a with L bends 142, 143 are now shown extended out, ready for installation where two sides are extended as illustrated in FIG. 8, but this time there is no need to fabricate two custom plates since they are built in to the fixture. Hinges 95 are also shown.

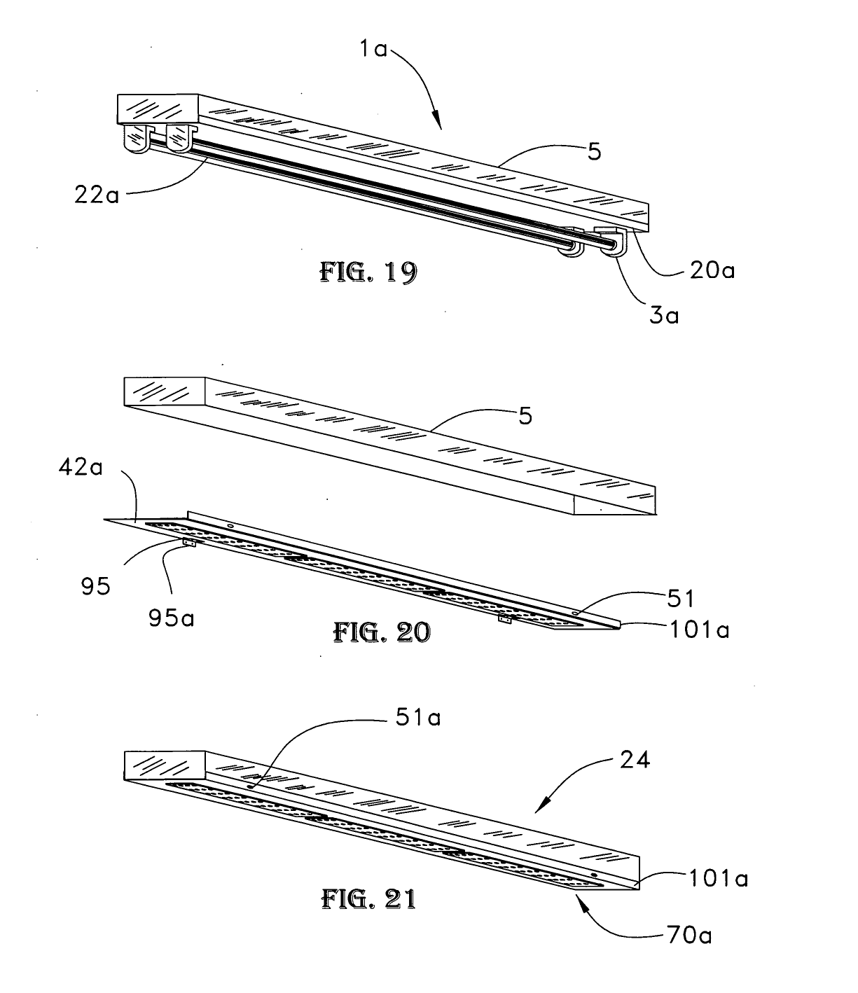

FIG. 19 shows a newer style of fluorescent light fixture 1a mounted on a ceiling without it being in a ceiling cavity. Newer style tubes 22a with their sockets 3a are mounted on front face 20a and then all said items are mounted on old fixture housing 5.

FIG. 20 shows a new style of LED light fixture front face 42a and old housing 5 partially exploded mounted on a ceiling with no cavity. Note hinge 95 and one flange 95a left hanging which will be fastened to the distal side of housing 5. Note “L” bend 101a which will be used to fasten to proximal side of fixture housing 5. This is shown in FIG. 21. Note the holes 51 which will be used for fastening with screws 51a in the next figure. (Note: The “L” bend can be an integral part of the new LED fixture as well, with the “L” bend being fastened to the new fixture housing.)

FIG. 21 shows the FIG. 20 items all together, forming the re-furbished fixture 24. Note the screw heads 51a on L bend 101a holding the front face assembly 70a to the housing. (The distal side with the fastened hinges is not shown).

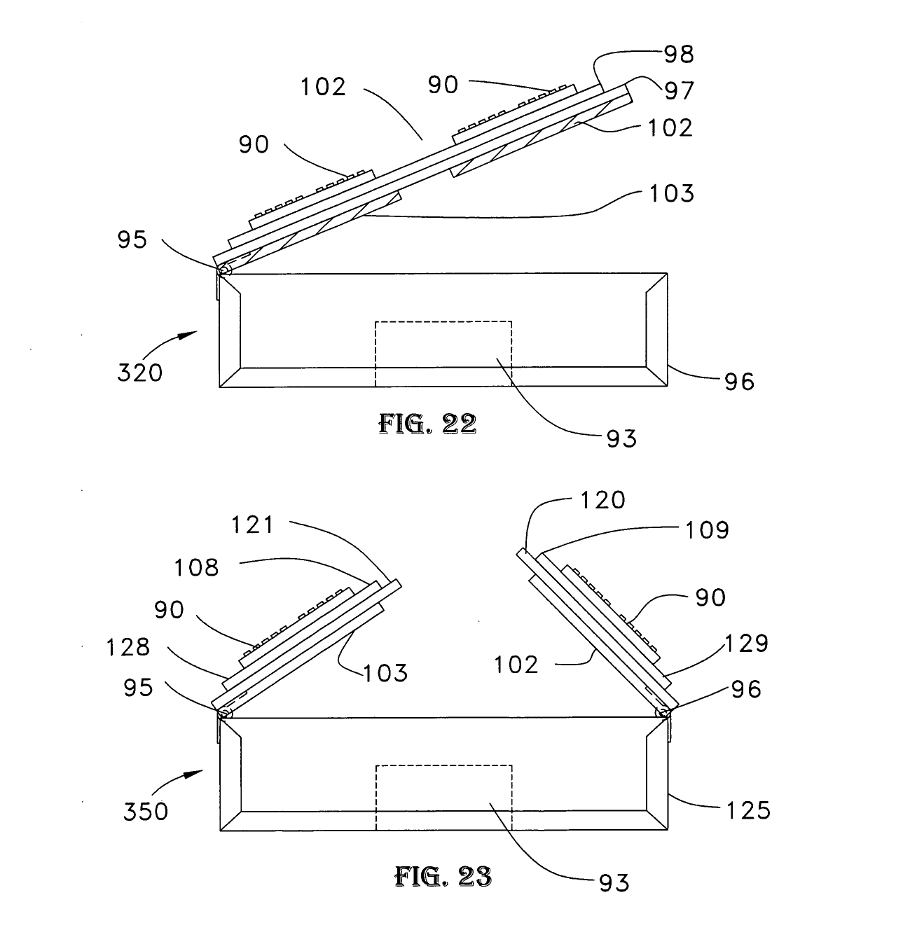

FIG. 22 shows an assembled end view of an LED fixture 320 of the present invention. It consists of LED light panels 90 mounted on a plate 98 which in turn is affixed to a front face plate 97. Two slide plates 102, 103 are shown. Hinges 95 are also shown. The LEDs 90 and LED base plate 98 and front face 97 and slide plates 102, 103 are all shown opened up pivoting on hinges 95. The purpose of this is twofold; one is for servicing the ballast and wiring and the other is for angular mounting of the front face assembly for purposes of LED light directing at an angle without tilting the entire fixture. An example of this would be ceiling to wall corner placement or for signage or billboard illumination.

### SIXTH EMBODIMENT OF THE PRESENT INVENTION

FIG. 23 shows an assembled end view of an LED fixture 350 of another embodiment of the present invention. It consists of two sets of LED light panels 90 mounted on a plates 128, 129 affixed to front face plates 120, 121. Two slide plates 102, 103 are shown. Hinges 95, 96 are also shown. The LEDs 90 and LED base plates 128, 129 and front faces 120, 121 and extender plates 102, 103 are all shown opened up pivoting on hinges 95, 96. The purpose of this is twofold; one is for servicing the ballast and wiring and the other is for angular mounting of the front face assembly for purposes of LED light directing at two independent angles without using two fixtures.

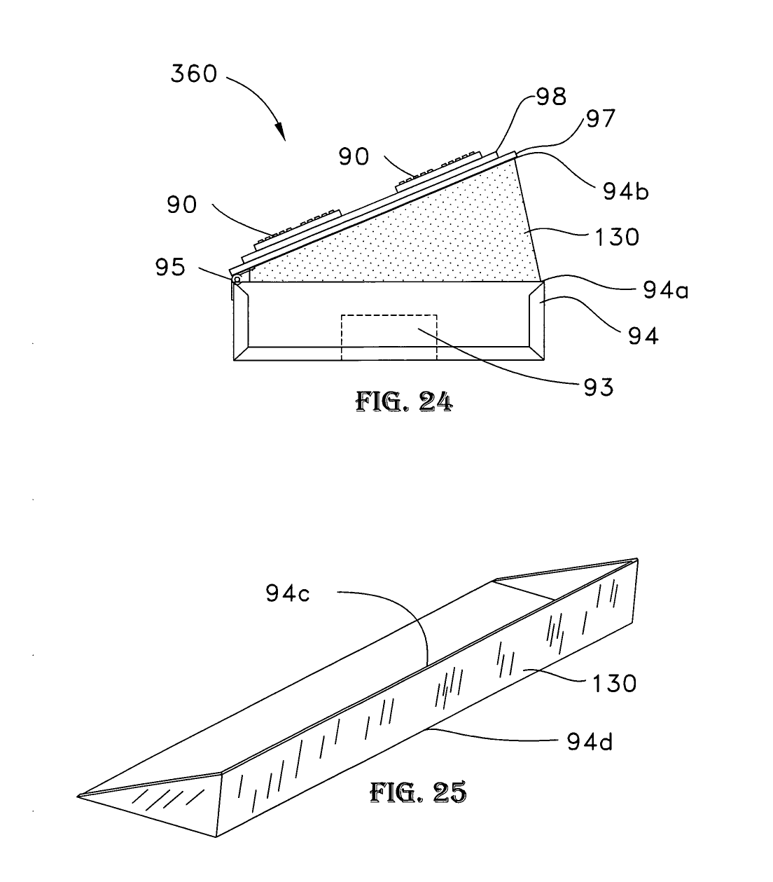

FIG. 24 shows an assembled end view of an LED fixture 360 of the present invention. It consists of LED light panels 90 mounted on a plate 98 which in turn is affixed to a front face plate 97. Hinges 95 are also shown. The LEDs 90 and LED base plate 98 and front face 97 are all shown opened up pivoting on hinges 95. The purpose of this is twofold; one is for servicing the ballast and wiring and the other is for angular mounting of the front face assembly for purposes of LED light directing at an angle without tilting the entire fixture. Additionally, a custom sheet metal cover 130 is provided which covers both the two ends of the fixture and the long side. The said cover's rim 94c and bottom bend 94d (FIG. 25) is usually fastened to the rim (edge) 94a portion of the housing and the corresponding rim (edge) 94b portion of the face plate using common sheet metal fastening techniques. This is only an example and there are many other methods available to the installation professional.

FIG. 25 shows a perspective view of the cover 130.

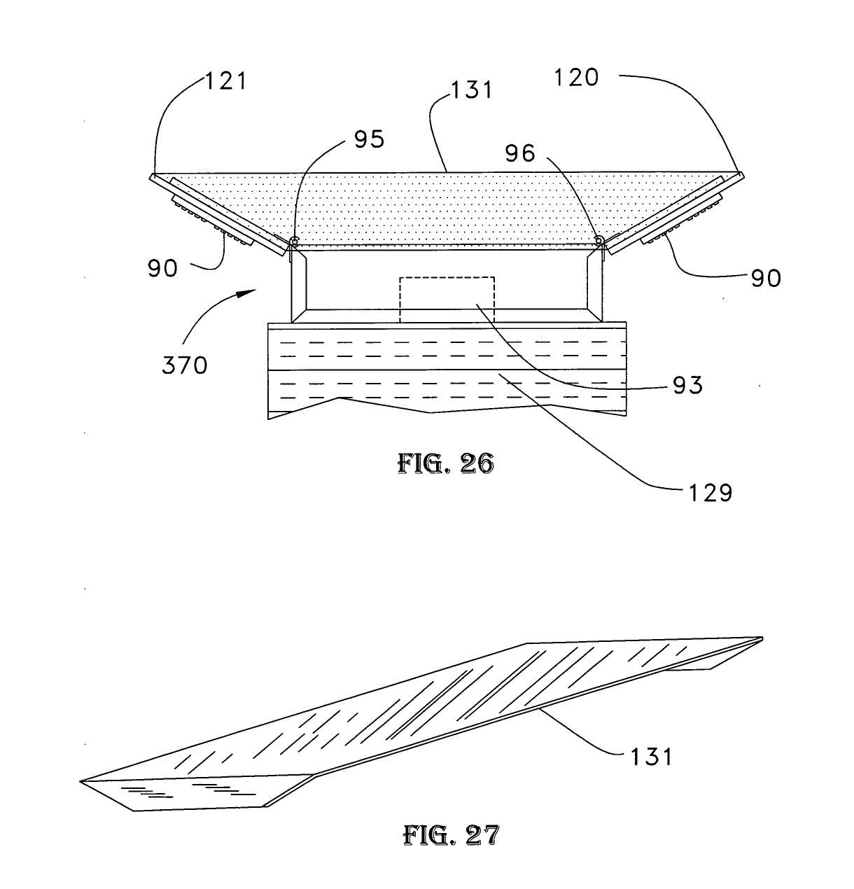

FIG. 26 shows an assembled end view of an LED fixture 370 of another embodiment of the present invention. This fixture uses two split halves of the previously described LED fixtures, each half section having its own set of hinges 95, 96. It consists of LED light panels 90 mounted on front faces 120, 121. As discussed in the description of FIG. 17, this LED light directing at two independent angles without using two fixtures can be placed atop a room divider 129 to light two sides. An example would be a lab or workshop with benches on each side of a room divider wall 129. Additionally, a custom sheet metal cover 131 is provided which covers both the two ends of the fixture and the long side.

FIG. 27 shows a perspective view of the cover 131. It should be noted that both covers 130 and 131 could be fabricated with two or more sheet metal segments that interleave with each other so that if an angular adjustment needs to be done, the said covers could interleave to a larger or lesser angle as needed. This feature is not illustrated, but is mentioned for purposes of completeness of this teaching. The same method for fastening as described for FIG. 24 can be used here as well.

### SEVENTH EMBODIMENT OF THE PRESENT INVENTION

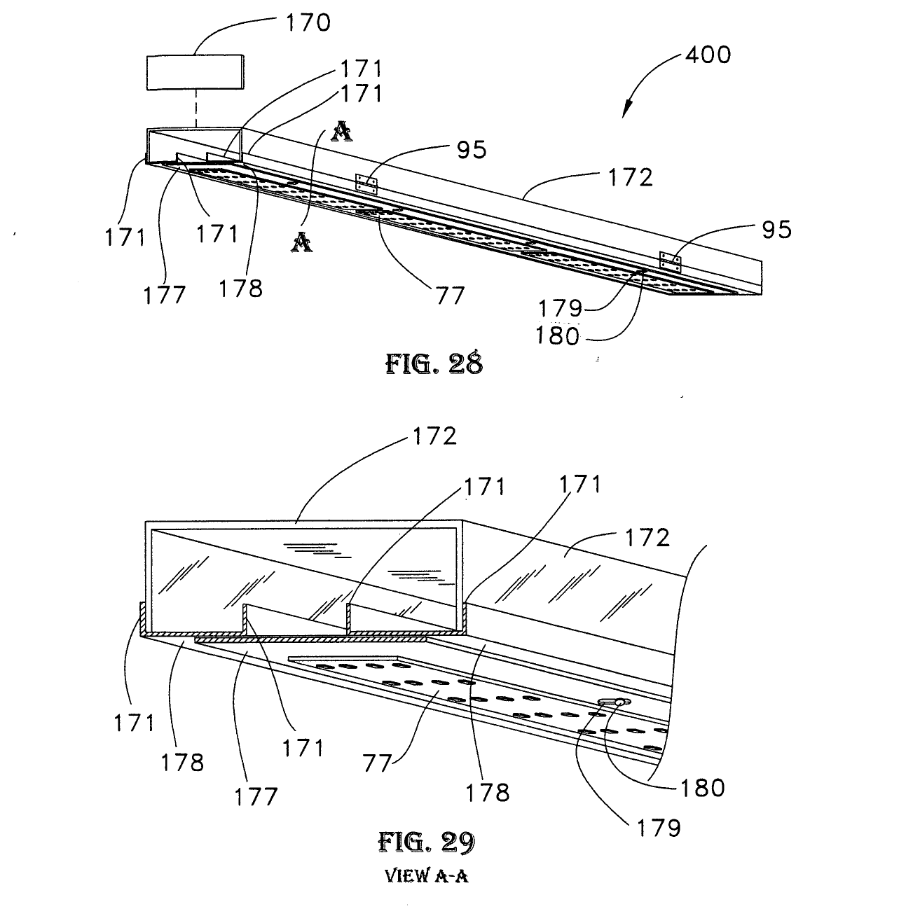

FIG. 28 shows an assembled view of an LED fixture 400 of the present invention wherein one end piece 170 is moved up to show inner parts. It consists of LED light panels 77 mounted on a front face 177 which in turn is affixed to two slide plates 178, each with two L bends 171 shown mounted to housing 172 using hinges 95 on a first (proximal) side and sheet metal screws (not shown) on the second (distal) side. Note that the said hinges are not mounted to the face plate 177, but to an appropriate L bend 171. A plurality of slots 179 are made on the face plate 177. Fasteners 180 engage each in their slot and fasten to a slide plate immediately above as shown. This is shown more clearly in FIG. 29. Note line A-A for the next figure.

FIG. 29 shows a magnified view of a portion similar to FIG. 28 to the left of line A-A. It consists of LED light panels 77 mounted on a front face 177 which in turn is affixed to two slide plates 178, each with two L bends 171 shown mounted to housing 172. A plurality of slots 179 are made on the face plate 177. Fasteners 180 engage each in their slot 179 and fasten to a slide plate immediately above. This is a variation. The dual L bends 171 provide more stiffness for longer LED light fixtures. Fasteners 180 are initially able to slide in the slots 179, but can be made to tighten when in place or left as is. As a further note, the face plate can be adjusted about the X axis for centering the LED array panels 77.

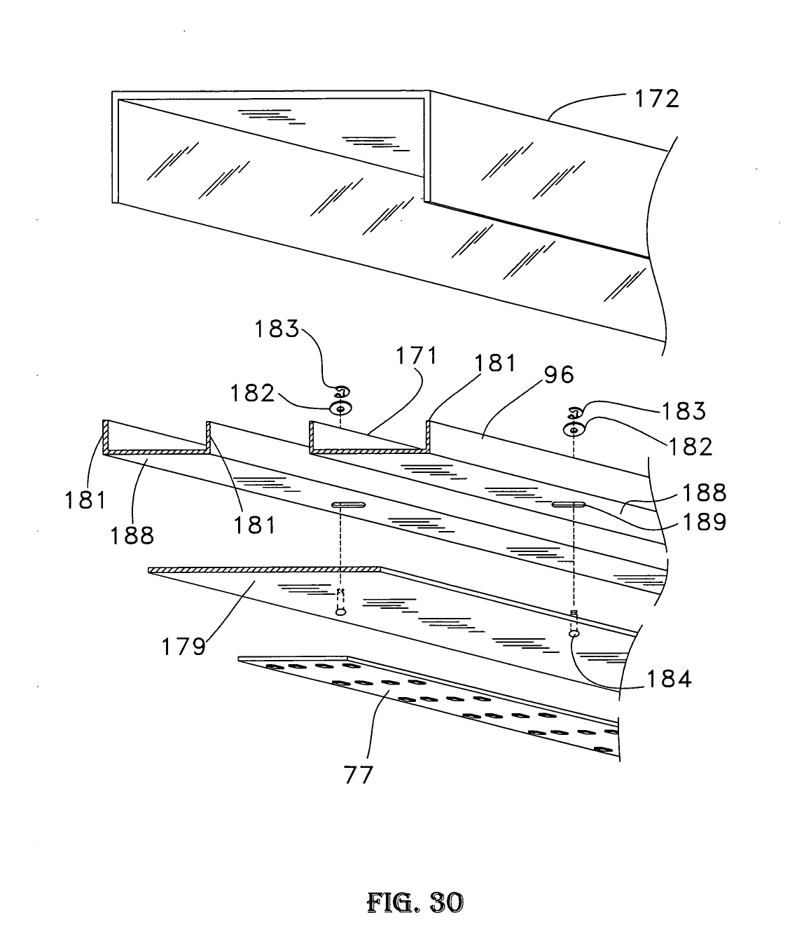

FIG. 30 shows a magnified exploded view of a portion similar to FIG. 28 to the left of line A-A. It shows a variation in fastening the face plate 179 to the pair of double L bend 181 movable plates 188. There are no slots on the face plate 179, but now they are placed on the pair of movable plates 188. Studs 184 are affixed to the face plate 179 as shown in the figure and a washer 182 and clip 183 arrangement is used to fasten the face plate 179 and the said double L bend movable plates 188. This is a more ascetically pleasing design because the slots 189 are not visible since they are hidden behind the face plate 179.

Present LED Technology as Used for Lighting Purposes.

LED lighting is fast becoming as ubiquitous as the incandescent bulb was in the last century. Worldwide, manufacturers and lighting contractors are scrambling to get a piece of the action in this business. Generally, LEDs for lighting purposes come in two classes and two types within those classes.
Class 1—High power LEDs—greater than 1 Watt dissipation.
Class 2—Low power LEDs—less than 1 Watt dissipation.
   The two types in both those classes are:

1. Wide angle luminance, about 100-165 degrees in a scattered fashion due to a flat LED emitting face.
2. Narrow angle luminance, about 20-60 degrees typically in Lambertian fashion due to a molded in lens.
   LEDs used in the present invention are mostly of the low power type because they are individually inexpensive and are thermally manageable. High power LEDs are difficult to keep cool. A typical fixture of the present invention can use several hundred low power LED devices, each with less than one watt dissipation. They are relatively easy to keep cool since the LEDs are spread over a wide area.

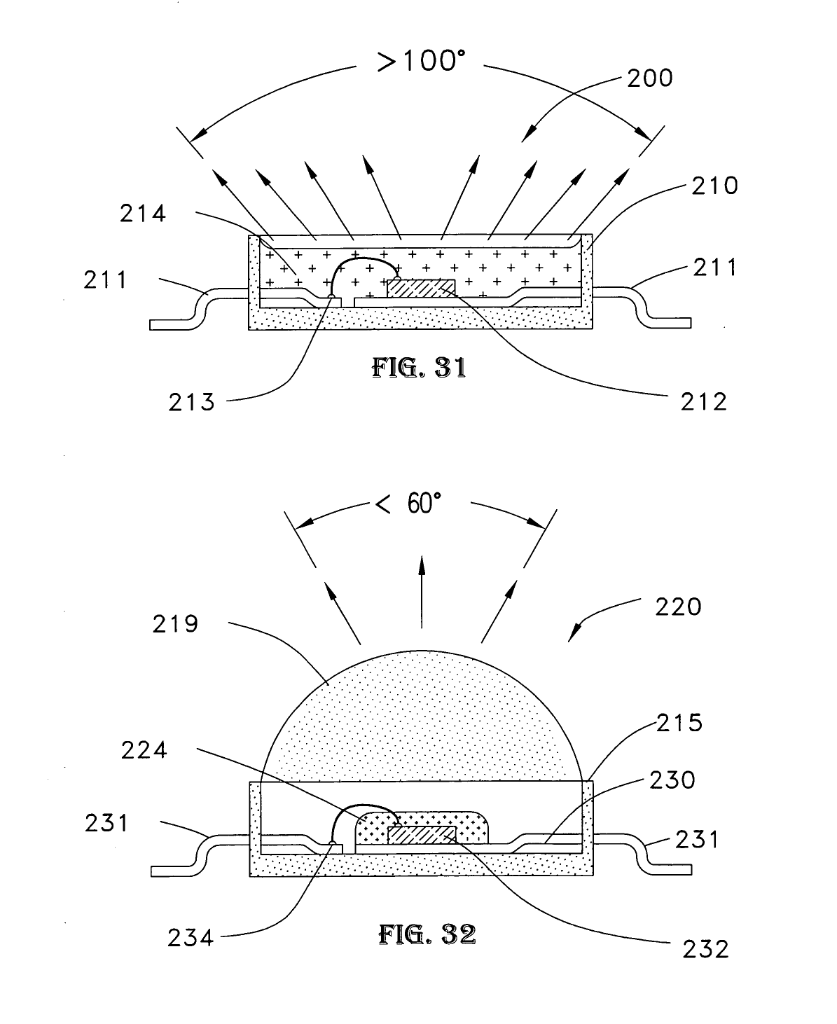

FIG. 31 illustrates a sectional view of a low power surface mount LED 200 with wide angle characteristics. It consists of a housing 210, a copper lead frame 211, upon which is bonded a light emitting silicon chip 212. A wire bond 213 connects the top section of chip 212 to the other lead 211 (left copper lead in FIG. 28). A rather large phosphor fill 214 is provided which emits white light. The copper leads 211 provide conductive heat transfer to a printed circuit board (not shown) on which the LED 200 is soldered.

### Pause in Figure Descriptions.—Inventor's Comment.

Presently, there is no such device as a “white light” emitting diode. All light emitting diode chips emit an almost monochromatic light of predominantly one wavelength or a few closely spaced wavelengths. White LEDs use blue or ultra violet light emitting silicon chips. This blue or ultra violet light excites the phosphor 214 which in turn emits white light by a process known as the Stokes shift emission. Using an appropriate mix of phosphor types, a white light can be produced. For example a white LED can be made that is “a warm white” or “a cool white”. This is the same as in fluorescent tube technology—obviously so—they both use phosphors for white light emission.

### Figure Descriptions Continued,

FIG. 31 illustrates a sectional view of a low power surface mount LED 220 with narrow angle characteristics. It consists of a housing 215, a copper lead frame 231, upon which is bonded a light emitting silicon chip 232. A wire bond 234 connects the top section of chip 232 to the other lead 231 (left copper lead in FIG. 29). Unlike in the wide angle LED shown in FIG. 31, a relatively compact phosphor covering 224 surrounds the chip which emits white light in an intense almost point source configuration. A molded focusing lens 219 is also provided. The lens 219 in combination with the mentioned small phosphor 224 area narrows the light emission angle considerably. The copper leads 231 provide conductive heat transfer to a printed circuit board (not shown) on which the LED 220 is soldered.

High power LEDs (not illustrated) generally use a copper or aluminum slug under chip 212, 232 which protrudes thru the bottom of housing 210, 215 which is then thermally bonded to an appropriate heat sink during the assembly phase of the LED illuminating apparatus. The leads 211, 231 are generally also a surface mount type.

### SUMMARY RAMIFICATIONS AND SCOPE

The fixtures described in this teaching provide the installation professional several advantages, some of which are summarized as follows:
1. Low cost.
2. Universal mounting positions.
3. Minimum installation labor.
4. Retrofit versatility.
5. Absolute minimum on-site custom sheet metal fabrication.
6. Angular light dispersion capability for LED fixtures.
7. Angular light direction capability for LED fixtures.
8. Light weight.
9. Low power consumption.

### OTHER EMBODIMENTS NOT ILLUSTRATED

A hidden feature of LED light fixtures is that these fixtures can be made to produce white, red, green, blue or yellow light. For example a yellow or red light fixture may be used in a chemistry lab or photo processing lab where white light is not desired. Indeed the same fixture could be made to have two or more color LEDs so that one fixture can perform both jobs as necessary. This was not easily done with fluorescent light fixtures of the past. Furthermore RGB LED lights can produce all colors necessary by controlling the power to each of the three led devices. Generally this is done using Pulse Width Modulation techniques which will not be described here since it is well understood in the art. These features can be controlled remotely by Power Line Signal or Optical Signal or Radio Frequency Signal means. Software control of these LED light fixtures is also available in myriad forms. For example Blue Tooth technology and/or cell phone technology etc. capability is available. They will not be described since they also are well known in the art. These control devices are available on the commercial market as complete modules. Most are covered by their own patent portfolios; thus this disclosure does not claim their specific technology, but does claim the use of these said control devices in the specific environment of LED replacement light fixtures described herein.

When installing multiple rows of LED fixtures such as in a long hallway of a hospital for example, then the individual row or column of each light fixture could be sequentially switched on and off, producing a “running lights” effect so that a person could be directed to a particular destination. Presently hospitals use painted lines on the floor or wall to do this. This invention makes these “running lights” programmable, variable to any destination desired. These features can be switched on or off at will. Furthermore, if the LED light fixtures are RGB LEDs, only one row or column of a particular color could be selected for the previously said purposes thus minimally interrupting the lighting conditions.

These RGB LED fixtures can also be used for alarm or evacuation purposes by using the previously said techniques and color changes of selected lights leading to exits. They can also be used for white light variations such a “warm white” for winter and a “cool white” for summer etc. (“Warm white” is a lower color temperature tending towards the yellow whereas a “cool white” is a higher color temperature tending towards the blue.).

Additional Capability of LED Lighting Devices.

Additional capabilities that are possible with LED lighting fixture are, but are not limited to:
a. Remote control of light intensity.
b. Remote control of light color.
c. Remote control of light duration.
d. Remote communication using a variety of wireless signaling methods.
e. Self-dimming according to sun or other natural light conditions.
f. Remote or local control of the above features using voice recognition technology.
g. Fire alarm initiation using built in sensors and any of the above control methods.
h. Intruder detection using built in occupancy sensors and any of the above control methods.
i. Audible announcements using built-in loudspeakers in the said LED light fixtures.
j. Multiple remote units to perform the above functions.
k. Hand held unit/units to perform the above functions.
l. Software control capability.
m. Two-way communication between any installed LED light fixture, using a dedicated control unit or a cell phone device, tablet device or a house power/light management device etc. each using its own custom software.
n. Code locking/unlocking functions to any selected light fixture.
o. Cell phone coding capability to perform any of the above functions.
   These examples and many more can be possible using today's modern ultra-miniature electronic assembly techniques.

Future Capability of Solid State Lighting Devices.

Solid state semiconductor based lighting device technology is progressing almost faster than we the inventors can invent applications for their use. In that vein here are presented some aspects of the present invention capable of using these future devices. For example:
a. Non-silicon based light emitting technology. For example but not limited to, OLED devices.
b. Self-regulation of current consumption, eliminating the need of constant current ballasts.
c. Zero power (In reality, near-zero-power) self-regulation of current using on-chip very fast pulse technology.
d. Positive temperature coefficient solid state lighting devices, eliminating the need for constant current ballasts.
e. Self-regulation of light output or light color.
f. Wireless remote control of light intensity.
g. Wireless remote control of light color.
h. Wireless remote control of light duration.
i. Wireless software control capability for other functions.

All these science-fiction-like technologies are here now, living in development laboratories. As costs are reduced, they will be introduced to the world. As an example, said patent U.S. Pat. No. 9,112,173 to Mitsuya discusses high brightness and long life OLED technology.

The said wireless controls and/or self-regulation are designed on the LED chip directly. Generally the LED chip will have only a power and ground lead connection. The LED chip will communicate via radio signals, power line signals or optical signals etc. with a remote device. Other high end semiconductor devices have already been built with on-chip wireless communication capability. No doubt they will soon be available on the lowly LED devices.

This inventor claims all these aspects of the novelty and the claims section of this patent reflect this clearly. Although the descriptions above contain many specificities these should not be construed as limiting the scope of the invention but as merely providing illustrations of some of the presently preferred embodiments of this invention. Thus the scope of the invention should be determined by the appended claims and their legal equivalents rather than by the examples provided.

The claims are not limited to the various aspects of this disclosure, but are to be afforded the full scope consistent with the language of the claims. All structures and functional equivalents of the elements of the various aspects described throughout this disclosure that are known or are later come to be known to those skilled in the art are expressly incorporated herein by reference and are intended to be encompassed by metes and bounds of the claims. Additionally, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or in the case of a method claim, the element is recited using the phrase “step for”.

What is claim is:

1. A method of replacing the front face assembly of an existing fluorescent light fixture with a new front face assembly that has the capability of dimensionally variable mechanical coupling where the new front face consists of
at least one fluorescent tube plugged into at least one socket and
at least one face plate upon which the said at least one fluorescent tube plugged into at least one said socket are mounted and
at least one moveable plate with a capability of providing a dimensional adjustment capability of the said new front face assembly and
said movable plate for mechanical coupling of the combined assembly of the said at least one front face plate assembly and
said movable plate to an existing fluorescent light fixture that has had its front face assembly and optionally selected other of its parts removed.

2. A method of replacing an existing fluorescent light fixture with a new fluorescent light fixture that has the capability of variable mechanical coupling of the front face of the new fluorescent light fixture wherein
the new fluorescent light fixture consists of a housing and
at least one fluorescent tube plugged into at least one socket and at least one face plate upon which the said one fluorescent tube
plugged into at least one said socket are mounted and
at least one moveable plate with a capability of providing a
dimensional adjustment capability of the said front face and
said movable plate for mechanical coupling of the combined assembly of the said at least one front face plate and said movable plate and the said fluorescent tube and
said socket and the new fluorescent light fixture housing to
an existing fluorescent light fixture cavity wherein
the old fixture has been removed.

3. A method of replacing an existing fluorescent light fixture with a new fluorescent light fixture that has the capability of variable mechanical coupling of the said front face of the new fluorescent light fixture wherein
the new fluorescent light fixture consists of a housing and
at least one fluorescent tube plugged into at least one socket and at least one front face plate upon which the said one fluorescent tube plugged into at least one said socket are mounted and at least one moveable plate with a capability of providing a dimensional adjustment capability of the said front face and said movable plate for mechanical coupling of the combined assembly of the said at least one face plate and
said movable plate and the said fluorescent tube and
said socket and the new fluorescent light fixture housing to
an existing non-cavity mounted fluorescent light fixture site wherein the said old non-cavity mounted fluorescent light fixture has been removed.

4. A method of replacing an existing non-fluorescent light fixture with a new fluorescent light fixture that has the capability of variable mechanical coupling of
the front face of the new fluorescent light fixture wherein
the new fluorescent light fixture consists of a housing and
at least one fluorescent tube plugged into at least one socket and at least one face plate upon which the said one fluorescent tube,
plugged into at least one said socket arc mounted and
at least one moveable plate with a capability of providing a
dimensional adjustment capability of the said front face and
said movable plate for mechanical coupling of the
combined assembly of the said at least one front face plate and said movable plate and the said fluorescent tube and
said socket and the new fluorescent light fixture housing to
an existing non-fluorescent light fixture wherein
the old non-fluorescent fixture has been removed.

5. A fluorescent light fixture including,
a housing and
at least one fluorescent lube plugged into
at least one socket and
at least one face plate upon which the said at least one fluorescent tube plugged into at least one said socket are mounted and
at least one moveable plate with a capability of providing a
dimensional adjustment capability of the said front face plate assembly and said movable plate for mechanical coupling of the
combined assembly of the said at least one front face plate and said movable plate and said housing to a selected area.

6. A fluorescent light fixture of claim 5 wherein the at least one said movable plate is mounted above the front face plate.

7. A fluorescent light fixture of claim 5 wherein the at least one said movable plate is mounted below the front face plate.

8. A fluorescent light fixture of claim 5 wherein the at least one said movable plate has an “L” bend to facilitate fastening to the side of a housing fixture.

9. A method of replacing the front face of an existing fluorescent light fixture with a new LED front face containing an LED array assembly that has the capability of dimensionally variable mechanical coupling where
at least one LED array assembly is mounted and
at least one moveable plate with a capability of providing a
dimensional adjustment capability of the said front face assembly and said movable plate for mechanical coupling of the combined assembly of the said at least one front face plate with the said LED array assembly to an existing fluorescent light fixture,
having its front face assembly and optionally selected other of its parts removed.

10. A method of replacing an existing fluorescent light fixture with a new LED light fixture that has the capability of variable mechanical coupling of the front face of the new LED light fixture wherein
the new LED light fixture consists of a housing and
at least one LED array and
at least one face plate upon which the said at least one LED array is mounted and at least one moveable plate with a capability of providing a dimensional adjustment capability of the said front face for mechanical coupling of the combined assembly of the said at least one front face plate and
the said at least one LED array and fixture housing to an existing fluorescent light fixture cavity wherein the old fixture has been removed.

11. A method of replacing an existing fluorescent light fixture with a new LED light fixture that has the capability of variable mechanical coupling of the front face of the new LED light fixture wherein
the new LED light fixture consists of a housing and
at least one LED array and
at least one face plate upon which the said at least one LED array is mounted and at least one moveable plate with a capability of providing a
dimensional adjustment capability of the said front face using
said movable plate for mechanical coupling of the
combined assembly of the said at least one front face plate and the said movable plate and the said at least one LED array and fixture housing to
an existing fluorescent light fixture that is not mounted in a cavity.

12. A method of replacing an existing non-fluorescent light fixture with a new LED light fixture that has the capability of variable mechanical coupling of the front face of the new LED light fixture wherein
the new LED light fixture consists of a housing and at least one LED array and
at least one face plate upon which the said at least one LED array is mounted and
at least one moveable plate with a capability of providing a
dimensional adjustment capability of the said front face for
mechanical coupling of the combined assembly of
the said at least one front face plate and
the said at least one LED array and fixture housing to
an existing non-fluorescent light fixture site wherein the old fixture has been removed.

13. A LED fluorescent light replacement fixture including,
a housing and
at least one LED array assembly which said LED array can
consist of a selection of LED light emitting colors in the visible and invisible optical range as perceived by the human eye and wherein the selection can be a mixture of colors and
the said mixture can also be of a different
type/s of light emitting device/s and
other solid state light emitting device/s and
at least one face plate upon which the said
at least one LED array assembly are mounted and
at least one hinge mechanism with
one leaf of the said hinge coupled to a first selected position and the other leaf mounted to a second selected position and
at least one moveable plate which said movable plate can
contain at least one L bend on a selected side/s and
the said movable plate having a capability of providing a
dimensional adjustment capability of the said front face using
the said movable plate for mechanical coupling of the
combined assembly of the said at least one front face plate and the said LED array assembly and the said housing to a desired location and wherein
the said LED fluorescent light replacement fixture can receive and transmit various control signals, both wireless and wired as desired and wherein
the said LED fluorescent light replacement fixture can be configured to perform the function of a master/slave unit during the performance of the said receive/transmit functions as desired and wherein
the said LED fluorescent light replacement fixture can optionally contain various devices selected from the following list:
a. at least one ambient light sensor for automatic brightness control,
b. at least one occupancy sensor for on/off control based on occupancy in the general vicinity,
c. at least one timer device to turn the lights off after a pre-determined time,
d. at least one room temperature sensor,
e. at least one pyro electric flame sensor,
f. at least one loud speaker device,
g, at least one electro-acoustic device;
for control of various user programmable functions and optionally including the spectral emission of said LED array/arrays to produce a desired light color and
alarming functions such as detection of a fire and
public address functions, and
capable of receiving/transmitting at least one of the following signals:
a. Optical signals,
b. Audible signals,
c. Wired signals,
d. Radio frequency signals for
personnel evacuation and other purposes including:
a. Warning personnel of intruder,
b. Warning personnel of fire,
c. Signaling personnel for fire drill,
d. Signaling personnel audibly or visually,
e. Leading visitors to desired locations visually/audibly,
f. Performing public address using the said built-in loudspeaker/electro acoustic device.

14. A LED fluorescent light replacement fixture of claim 13 wherein
the at least one movable plate is mounted above the front face plate.

15. A LED fluorescent light replacement fixture of claim 13 wherein
the at least one movable plate is mounted below the front face plate.

16. A LED fluorescent light replacement fixture of claim 13 wherein
the at least one hinge mechanism is made of a selection of materials including metal, metal alloy, plastic, a plastic and metal mixture and
a fiberglass composite and other polymers, wherein
the said plastic and other polymers hinge can be a plastic deformation type of hinge.

17. A LED fluorescent light replacement fixture of claim 13 wherein
some movable plate/s can be mounted above a face plate while
other said movable plate/s can be mounted below a face plate/s.

18. A LED fluorescent light replacement fixture of claim 13 wherein the at least one movable plate/s are removed and not used.

19. A LED fluorescent light replacement fixture of claim 13 wherein the Light Emitting Diodes emit a relatively narrow spectrum light perceived as a generally red light to the human eye.

20. A LED fluorescent light replacement fixture of claim 13 wherein the Light Emitting Diodes emit a relatively narrow spectrum light perceived as a generally green light to the human eye.

21. A LED fluorescent light replacement fixture of claim 13 wherein the Light Emitting Diodes emit a relatively narrow spectrum light perceived as a generally blue light to the human eye.

22. A LED fluorescent light replacement fixture of claim 13 wherein the Light Emitting Diodes emit a relatively narrow spectrum light perceived as a generally yellow light to the human eye.

23. A LED fluorescent light replacement fixture of claim 13 wherein the Light Emitting Diodes emit a relatively narrow spectrum light in the ultra violet range.

24. A LED fluorescent light replacement fixture of claim 13 wherein the Light Emitting Diodes are tri-color devices capable of red, green and blue light emission (RGB Diodes); each having the ability of individual activation.

25. A LED fluorescent light replacement fixture of claim 13 wherein the Light Emitting Diodes can be activated by controlling power to selected light emitting diodes by a selection of techniques such as, Pulse Width Modulation Control, Variable Direct Current Control, Power Line Signal Control, Ultrasonic Acoustic Signal Control, Voice Recognition Signal Control, Radio Frequency Signal Control, Radio Frequency Blue Tooth Communication Control and Optical Signal Control.

26. A LED fluorescent light replacement fixture of claim 25 wherein the selected control functions are achieved by having the appropriate transmit/receive
control unit/units located at a selection of locations such as within the said housing, outside the said housing and partly inside and partly outside the said housing and corresponding command control/controls located at a remote location.

27. A LED fluorescent light replacement fixture of claim 26 wherein the said selected command control/controls consist of hand held devices.

28. A LED fluorescent light replacement fixture of claim 26 wherein the said selected command control/controls are located at a
central command/control console.

29. A LED fluorescent light replacement fixture of claim 13 wherein each column of the Light Emitting Diode arrays can be controlled sequentially.

30. A LED fluorescent light replacement fixture of claim 13 wherein each row of the Light Emitting Diode arrays can be controlled sequentially.

31. A plurality of LED fluorescent light replacement fixtures of the type cited in claim 13 wherein each LED fluorescent light replacement fixture has the capability of being individually controlled.

32. A LED fluorescent light replacement fixture control unit of claim 25 uses voice recognition technology and accepts voice control from a remote cell phone to perform its control functions of said LED fluorescent light replacement fixtures.

33. A LED fluorescent light replacement fixture control unit of claim 25 utilizing custom software for a cell phone using the said cell phone's cellular receiver/transmitter.

34. A LED fluorescent light replacement fixture control unit of claim 25 utilizing custom software for a cell phone using the said cell phone's Blue Tooth capability in conjunction with
the said LED fluorescent light replacement fixture's
Radio Frequency Receiver/Transmitter.

35. A LED fluorescent light replacement fixture of claim 25 wherein the control functions of said LED fluorescent light replacement fixture are controlled by custom software/firmware within the said LED fluorescent light replacement fixture.

36. A LED fluorescent light replacement fixture of claim 25 wherein the control functions of said LED fluorescent light replacement fixture are controlled by custom software/firmware outside the said LED fluorescent light replacement fixture.

37. A LED fluorescent light replacement fixture of claim 25 wherein the control functions of said LED fluorescent light replacement fixture are controlled by custom software/firmware outside and inside the said LED fluorescent light replacement fixture.

38. A LED fluorescent light replacement fixture of claim 25 wherein the control functions of said LED fluorescent light replacement fixture are controlled by custom software/firmware utilizing Blue Tooth Technology.

39. A LED fluorescent light replacement fixture of claim 25 wherein the control functions of said LED fluorescent light replacement fixture are controlled by custom software/firmware utilizing cellular phone receive/transmit signals via a LED fluorescent light replacement fixture control unit.

40. A LED fluorescent light replacement fixture of claim 25 wherein the control functions of said LED fluorescent light replacement fixture are controlled by custom software/firmware utilizing cellular phone receive/transmit signals via a plurality of LED fluorescent light replacement fixture control units.

41. A LED fluorescent light replacement fixture of claim 25 wherein the control functions of said LED fluorescent light replacement fixture are controlled by custom software/firmware utilizing cellular phone receive/transmit signals outside the said LED fluorescent light replacement fixture control unit.

42. A LED fluorescent light replacement fixture of claim 25 wherein the control functions of said LED fluorescent light replacement fixture are controlled by custom software/firmware utilizing cellular phone receive/transmit signals inside the said LED fluorescent light replacement fixture control unit.

43. A LED fluorescent light replacement fixture of claim 13 wherein the said LED fluorescent light replacement fixture contains a photo sensing device.

44. A LED fluorescent light replacement fixture of claim 13 wherein the said LED fluorescent light replacement fixture contains a computing device.

45. A LED fluorescent light replacement fixture of claim 13 wherein the said LED fluorescent light replacement fixture contains a data memory device.

46. A LED fluorescent light replacement fixture of claim 13 wherein the said LED fluorescent light replacement fixture contains a wireless transmission of a signal path to a photo sensor.

47. A LED fluorescent light replacement fixture of claim 13 wherein the said LED fluorescent light replacement fixture contains a wireless transmission of a signal path an occupancy sensor.

48. A LED fluorescent light replacement fixture of claim 13 wherein the said LED fluorescent light replacement fixture contains a dimming capability using Pulse Width Modulation technology.

49. A LED fluorescent light replacement fixture of claim 13 wherein the said LED fluorescent light replacement fixture contains a dimming capability using selected Pulse Repetition Frequency Modulation technology.

50. A LED fluorescent light replacement fixture of claim 13 wherein the said LED fluorescent light replacement fixture contains a dimming capability using selected Spread Spectrum Modulation technology.

51. A LED fluorescent light replacement fixtures of claim 13 wherein the said LED fluorescent light replacement fixture contains a plurality of temperature sensors.

52. A LED fluorescent light replacement fixtures of claim 13 wherein the said LED fluorescent light replacement fixture contains a plurality of pyro electric flame detectors facing in different directions.

53. A LED fluorescent light replacement fixture of claim 13 wherein the said LED fluorescent light replacement fixture contains a plurality of OLED devices.

54. A LED fluorescent light replacement fixture of claim 13 wherein the said LED fluorescent light replacement fixture contains a plurality of LED devices that have self-controlled current limiting capability.

55. A LED fluorescent light replacement fixture of claim 13 wherein the said LED fluorescent light replacement fixture contains a plurality of LED devices that have self-controlled zero power current limiting capability.

56. A LED fluorescent light replacement fixture of claim 13 wherein the said LED fluorescent light replacement fixture contains a plurality of LED devices that have self-regulation of light output.

57. A LED fluorescent light replacement fixture of claim 13 wherein the said LED fluorescent light replacement fixture contains a plurality of LED devices that have self-regulation of light color.

58. A LED fluorescent light replacement fixture of claim 13 wherein the said LED fluorescent light replacement fixture contains a capability of being a master unit.

59. A LED fluorescent light replacement fixture of claim 13 wherein the said LED fluorescent light replacement fixture contains a capability of being a slave unit.

60. A LED fluorescent light replacement fixture of claim 13 wherein the said LED fluorescent light replacement fixture's front face/faces can be pivoted at an angle/angles relative to the housing and mounted at the said angle/angles and a custom cover plate/plates being affixed to the said faceplate/faceplates at least one rim portion and a housing rim portion using common sheet metal mounting techniques.

61. A LED fluorescent light replacement fixture of claim 13 wherein the said fixture has the capability of being mounted to a desired location by a selection of fastener locations including, the face plate/s, the movable plate/s, the said fixture's X axis side/s, the said fixture's Y axis side/s and the said fixture's one Z axis side opposite the face plate/s.

62. A LED fluorescent light replacement fixture of claim 13 wherein the housing of the said LED fluorescent light replacement fixtures is made of at least one from a selection of materials such as:
a. Ferrous metals,
b. Non-ferrous metals,
c. Ferrous metal alloys,
d. Non-ferrous metals alloys,
e. A mixture of ferrous and non-ferrous metals,
f. A mixture of ferrous and non-ferrous metals alloys.

63. A LED fluorescent light replacement fixture of claim 62 wherein the housing of the said LED fluorescent light replacement fixtures is made of at least one from a selection of materials such as:
a. Thermoset plastics,
b. Thermoset resins,
c. Epoxy resins,
d. Virgin polymers,
e. Composite polymers,
f. Binding agent and glass composite commonly called “fiberglass”,
g. Binding agent and carbon composite commonly called “carbon fiber”.

64. A LED fluorescent light replacement fixture of claim 62 wherein the non-metal housing of the said LED fluorescent light replacement fixtures is lined internally with at least one thermal interface material from a selection of
materials such as:
a. a layer of aluminum foil,
b. a layer of copper foil,
c. a layer of graphite coating,
d. a layer of graphene coating,
e. a layer of thermally conductive paint,
f. a layer of electrically conductive paint.
